(19) United States
(12) Patent Application Publication
(10) Pub. No.: US 2004/0143450 A1
(43) Pub. Date: Jul. 22, 2004

(54) Real estate transaction management system

(75) Inventor: Ari A. Vidali, Bloomington, IN (US)

Correspondence Address: RUSSELL E. FOWLER, II, ICE MILLER, ONE AMERICAN SQUARE, BOX 82001, INDIANAPOLIS, IN, 46282-0002, US

(73) Assignee: iProperty.com., Inc., Bloomington, IN (US)

(21) Appl. No.: 10/753,126

(22) Filed: Jan. 7, 2004

Related U.S. Application Data
(63) Continuation of application No. 09/638,571, filed on Aug. 14, 2000, now abandoned.

(51) Int. Cl. G06F 17/60

(52) U.S. Cl. 705/1

(57) ABSTRACT

A real estate transaction management system comprises a plurality of databases in communication with a central computer. The plurality of databases includes a listings database containing information about a plurality of properties and a transaction database including information about a plurality of real estate transactions. The central computer provides a plurality of customized websites for the participants of the real estate transactions, including agents, buyers, sellers, and service providers. The customized websites may be accessed by the respective parties using remote computers connected to the central computer using the Internet. Each customized website provides a communications tool for sending messages and receiving messages from the customized websites of the other parties. The customized websites of the buyer and the agent further provide a searching tool for allowing the buyer and the agent to search the listings database for properties that may be of interest to the buyer. The buyer's customized website also provides the buyer with the ability to submit a loan application using the system. During the negotiation and closing process, each of the customized websites provides a form completion tool which allows the parties to access various transactions forms. The system automatically completes relevant portions of each form based on information stored in the transactions database about the party's particular transaction. Services required for closing, such as inspection, title report or appraisal, may all be ordered from the service providers using the transaction management system.

### BACKGROUND

Transacting residential real estate is a complex process, typically involving fourteen different parties, including buyer, seller, buyer's agent and brokerage, seller's agent and brokerage, mortgage broker and originator, inspector, appraiser, title agent, escrow agent, insurance agent and underwriter. Communication between the parties is critical. The parties must coordinate numerous meeting times and schedule work completion deadlines before a real estate transaction can close. In the weeks before closing, buyers and sellers are very interested in knowing that other parties have met their deadlines and that all work will be completed by the target closing date. Buyers agents and sellers agents spend numerous hours contacting other parties to ensure that deadlines have been met and work is complete for closing.

Parties to real estate transactions typically attempt to communicate with each other through various traditional communications channels such as person-to-person, telephone, postal service, pager, e-mail, or voice mail. Communication between the parties is often redundant. For example, one party may leave both a voice mail and an e-mail message for one other party. With multiple communications received through multiple channels, it is difficult for each party to keep track of the various messages delivered through various communications channels. FIG. 1A shows a communications scheme for a typical prior art real estate transaction. According to this scheme, various parties, including agents 104, consumers 102, and transaction service providers 106 send multiple messages to a number of other transaction parties using a number of different communications platforms 116. As displayed by FIG. 1A, the lines of communication between various transaction parties are cluttered, and information is easily misplaced or forgotten because of the confusion. Consumers, i.e., real estate customers in the form of buyers and sellers, are at the mercy of the process as they struggle to communicate with each other and conduct business. Thus, it would be advantageous to provide a real estate transaction management system that eliminates the cluttered lines of communication in real estate transactions by linking all parties in a real estate transaction through a central communications platform.

As the parties to a real estate transaction struggle to communicate with each other and share information, they must also produce various documents required for closing. Between thirty and one hundred forms must be completed by the parties during the typical real estate transaction. Many of the forms completed by the parties require entry of redundant data. This results in a tiresome and grueling process of data entry and re-entry for all parties involved. A typical real estate transaction currently takes two to three months to close, and the amount of time required to complete form work contributes to this extended closing time. Thus, it would be advantageous to provide a real estate transaction management system which stores data completed on any transaction form and automatically enters that data on other forms requesting the same data, thus removing the need for redundant data entry.

Recent technology has provided a benefit to the real estate industry from an information sharing standpoint. In particular, multiple listing service (MLS) databases now exist which provide a collection of information about various homes, including written descriptions and photos. MLS databases provide agents with the ability to search the MLS databases and match home buyers with homes that potentially meet their needs and desires. Unfortunately, many MLS databases exist primarily in old-paradigm systems requiring dial-up infrastructure and distributed desktop installations. These old-paradigm systems are expensive for the real estate agents to maintain and do not facilitate technology upgrades and service extensions. In addition, MLS databases only assist in the preliminary real estate shopping process, and do nothing to help the parties toward closing the transaction.

The first phase of applying Internet technology to real estate resulted in the aggregation of MLS data in national portals, making MLS listings available to all consumers with access to the Internet. Seeing that the technology was available to assist consumers in the searching process, a few companies tried to remove the agent and completely automate the real estate transaction process. However, removal of the agent from the transaction process has not been successful, as consumers continue to request assistance from real estate professionals not only during searching, but also during the evaluation, negotiation and closing phases of a transaction. Professional assistance is important because buyers and sellers are typically unsophisticated in the field of real estate transactions, and therefore want or need a representative to guide them through the complicated transaction process. Furthermore, a home is generally the largest purchase a consumer will make during his lifetime, and most consumers do not wish to make the purchase without some professional advice. In short, real estate consumers continue to demand professional assistance during the home buying process, and real estate agents remain valuable resources to both buyers and sellers.

Even though buyers and sellers demand customer service from their agents, there is an increasing demand by buyers and sellers for agents to justify their fees. Agents typically demand 3-7% of the home selling price as an agent's fee when a home is sold. Unless the agent can bring real value to the transaction, his clients may be disappointed in this considerable fee and not return to the agent for the next transaction. Thus, it would be advantageous if the agent could provide increased customer service both during and after the transaction process by improving communication with the consumer, providing the consumer with important transaction and post-transaction information, and streamlining the transaction process for the consumer, resulting in a relatively efficient and pleasant home buying or selling experience.

For the foregoing reasons there is a need for a transaction management system which completely integrates all parties in a real estate transaction to improve communications between the parties. In addition, there is a need for a transaction management system that eliminates the need for redundant data entry when completing transaction forms, and provides for the completion of all forms required for closing through the system. Furthermore, there is a need for a transaction management system that recognizes the value of the agent, and increases the agent's value to the buyer and seller with improved customer service.

### SUMMARY

The present invention is directed to a method and apparatus that satisfies the need for a transaction management system which completely integrates all parties in a real estate transaction, including agent, buyer, seller, and service providers, and improves communications between the parties. The transaction management system also eliminates the need for redundant data entry when completing transaction forms, and provides for the completion of all forms required for closing through the system. Furthermore, the transaction management system increases the agent's value to the buyer and seller with improved customer service.

The transaction management system comprises a central computer and a plurality of databases, including a listings database containing information about a plurality of properties for sale. The central computer communicates with the plurality of databases to provide a plurality of customized websites available to the transaction parties using remote computers connected to the central computer using the Internet. Each customized website and associated web pages is also referred to as a workspace.

One type of workspace provided by the system is the agent workspace. The agent workspace includes an agent notice page which provides the agent with the ability to send messages to and view messages from the customized workspaces of other transaction parties. The agent workspace also includes an agent searching page which provides the agent with the ability to search for property information in the listings database. In addition, an agent recommendation option provides the agent with the ability to recommend one of the plurality of properties to the buyer for viewing on the buyer's customized workspace.

The buyer workspace includes a buyer searching option which provides the buyer with the ability to search for information about various properties in the listings database. After finding a particular property of interest using the searching option, the buyer may bookmark the property to make information about the property readily accessible form the buyer workspace. The buyer workspace also includes a buyer notice option which provides the buyer with the ability to view messages from and send messages to other workspaces. Once the buyer decides to make an offer on a property, the buyer may send a notice to his agent requesting the agent to submit an offer to the seller. After making an offer, the buyer may obtain financing using a financing option which provides the buyer with access to a loan application, the ability to complete the loan application, and the ability to submit the loan application to one of the plurality of service providers. A closing option is also provided for the buyer to keep the buyer updated on the status of closing documents.

Another type of workspace provided by the system is a seller workspace. The seller workspace includes a seller notice option which provides the seller with the ability to view messages from and send messages to other workspaces. The seller workspace includes a selling option which provides the seller with statistical information concerning the number of potential buyers who have viewed the seller's property while searching the listings database or bookmarked the seller's property. If a buyer wishes to make an offer on the seller's property, the seller may be informed of the offer details through an offers option. The seller may contact his agent to have a counter-offer submitted to the buyer. A closing option is also provided for the seller to keep the seller updated on the status of closing documents.

The system also provides service provider workspaces. Each service provider workspace includes a service provider notice option which provides the service providers with the ability to view messages from and send messages to other workspaces. In addition, the service provider workspace includes a new orders option which provides the service provider with a list of new service orders for acceptance or rejection by the service provider.

These and other features, aspects, and advantages of the present invention will become better understood with reference to the following description and appended claims.

### BRIEF DESCRIPTION OF THE DRAWINGS

FIG. 1A shows the current relationship connections between the parties to a real estate transaction;

FIG. 1B shows the relationship connections between the various participants in a real estate using the real estate transaction management system of the present invention;

FIG. 2 shows an overview of the components of the transaction management system of FIG. 1B;

FIG. 3 is an agent workspace page of the transaction management system of FIG. 2 showing agent contacts;

FIG. 4 is another agent workspace page of the transaction management system of FIG. 2 showing the ability of agents to add contacts;

FIG. 5 is another agent workspace page of the transaction management system of FIG. 2 showing the ability of agents to send notices to various contacts.

FIG. 6 is another agent workspace page of the transaction management system of FIG. 2 showing the ability of agents to create workspaces for contacts;

FIG. 7 is a contact workspace page of the transaction management system of FIG. 2;

FIG. 8 is another agent workspace page of the transaction management system of FIG. 2 showing upcoming agent closings;

FIG. 9A and FIG. 9B shows an exemplary property description from a MLS system that may be viewed through the agent workspace page;

FIG. 10 shows another agent workspace page of the transaction management system of FIG. 2 showing products and services that may be ordered from various service providers;

FIG. 11 shows an exemplary seller workspace of the transaction management system of FIG. 2 where the agent may conduct a search for properties;

FIG. 12 shows an exemplary property listing resulting from the search of FIG. 11;

FIG. 13 shows an exemplary buyer homepage of the transaction management system of FIG. 2;

FIG. 14 shows an exemplary buyer search page of the transaction management system of FIG. 2;

FIG. 15 shows an exemplary buyer financing page of the transaction management system of FIG. 2;

FIG. 16 shows an exemplary loan products page of the transaction management system of FIG. 2;

FIG. 17 shows an exemplary buyer closing page of the transaction management system of FIG. 2;

FIG. 18 shows an exemplary buyer learning page of the transaction management system of FIG. 2;

FIG. 19 shows an exemplary buyer community page of the transaction management system of FIG. 2;

FIG. 20 shows an exemplary seller home page of the transaction management system of FIG. 2;

FIG. 21 shows an exemplary selling page of the transaction management system of FIG. 2;

FIG. 22 shows an exemplary seller offers page of the transaction management system of FIG. 2;

FIG. 23 shows an exemplary seller closing page of the transaction management system of FIG. 2;

FIG. 24 shows an exemplary lender new orders page of the transaction management system of FIG. 2;

FIG. 25 shows an exemplary lender inactive orders page of the transaction management system of FIG. 2;

FIG. 26 shows an exemplary lender open order page of the transaction management system of FIG. 2;

FIG. 27 shows an exemplary lender detailed information page of the transaction management system of FIG. 2;

FIG. 28 shows an exemplary lender reports page of the transaction management system of FIG. 2;

FIG. 29 shows an exemplary lender administration page of the transaction management system of FIG. 2;

FIG. 30 shows an exemplary service provider new order page of the transaction management system of FIG. 2;

FIG. 31 shows an exemplary service provider service request page of the transaction management system of FIG. 2;

FIG. 32 shows an exemplary service provider canceled orders page of the transaction management system of FIG. 2;

FIG. 33 shows an exemplary service provider open orders page of the transaction management system of FIG. 2;

FIG. 34 shows an exemplary service provider reports page of the transaction management system of FIG. 2.

### DESCRIPTION

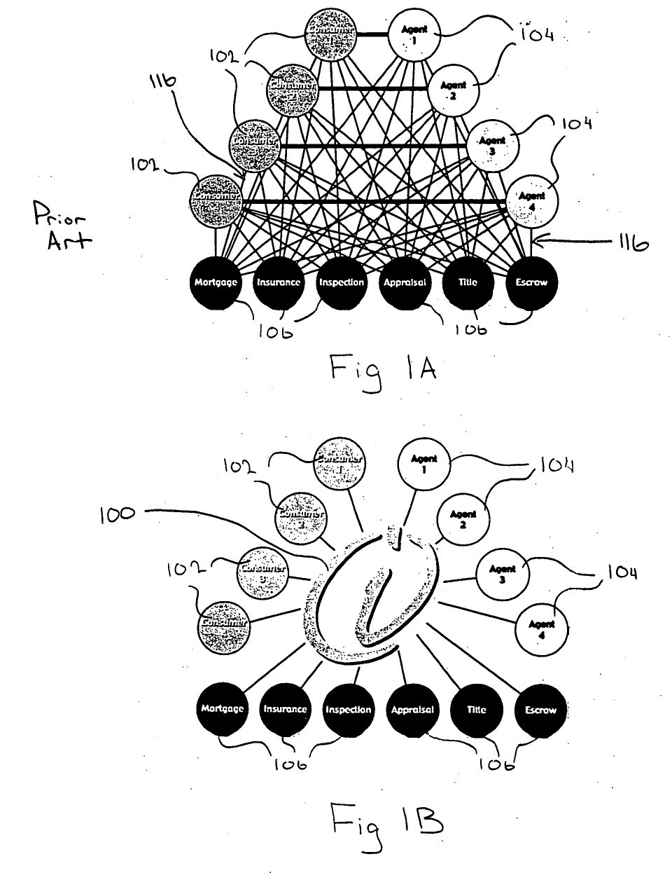

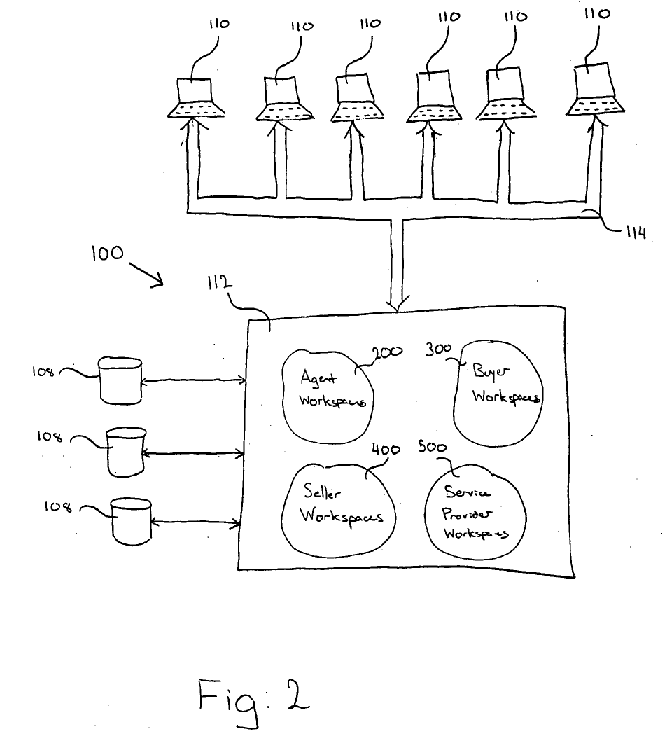

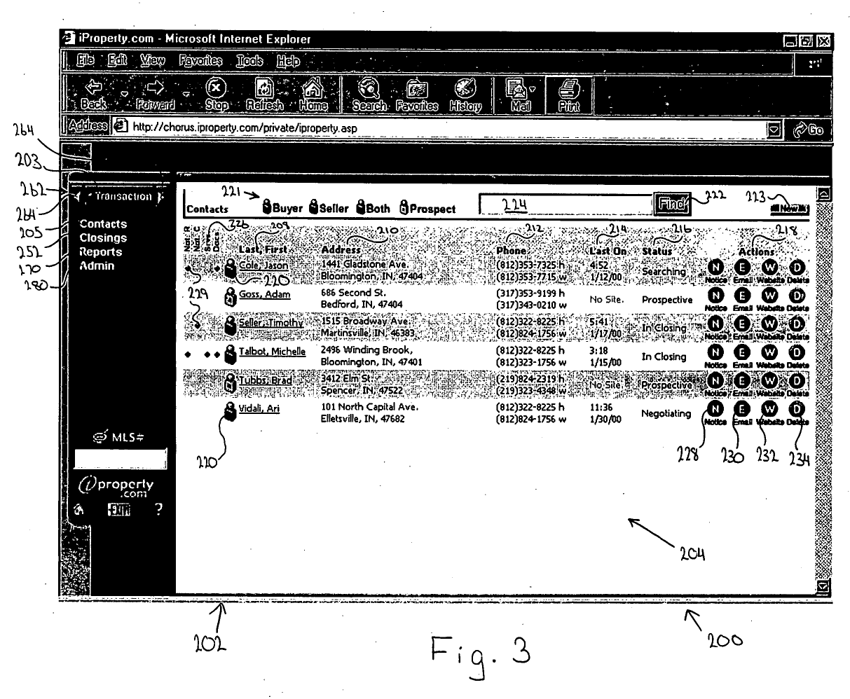

As shown in FIG. 1B, a real estate transaction management system 100 connects real estate buyers and sellers 102 with real estate agents 104 and other service providers 106 by allowing the parties to communicate and collaborate through a single transaction platform, specifically the transaction management system 100. The transaction management system 100, as shown in FIG. 2, connects a plurality of remote computers 110 using an interactive network 114, such as the Internet. The system 100 comprises a central computer known as a server 112 and a plurality of databases 108 containing information which may be selectively accessed by the server 112 and provided to the remote computers 110 over the Internet 114. The plurality of databases 108 may include, for example, a listings database containing information about a plurality of properties for sale and a transactions database containing information about a plurality of real estate transactions and a plurality of parties to the plurality of real estate transactions.

The server 112 executes software stored in the databases 108 and thereby provides a plurality of electronic workspaces within the transaction management system 100. The electronic workspaces are accessed using the remote computers 110 connected to the server 112 via the Internet 114. The electronic workspaces include agent workspaces 200, buyer workspaces 300, seller workspaces 400, and service provider workspaces 500. The term workspace as used herein refers to an individualized website having multiple web pages and designed for a particular user of the transaction management system. Each workspace allows a respective party to a real estate transaction to selectively access information contained within the databases 108 relevant to that party. Each workspace also allows the parties to communicate information to the workspaces of other transaction parties.

Each party using the real estate transaction system 100 is provided with a username and password upon registering to use the system 100. After obtaining a username and password, the party may log on to the system 100 using a remote computer 110. Parties log on to the system by connecting to the Internet and entering the uniform resource locator (URL) of the system 100 as the desired address. Once connected to the system 100, the system prompts the party for the username and password. Upon successful entry of a valid username and password, the server provides the party with access to one of the workspaces designed exclusively for that party. A party's personalized webspace will either be an agent workspace 200, buyer workspace 300, seller workspace 400, or service provider workspace 500. Each of these workspaces is explained in more detail below. The system 100 uses the workspaces as an interface between the parties. The system collects information from various parties through the workspaces and stores this information in the databases 108. All data transferred by the system is encrypted using a 128 bit secure sockets layer (SSL) connection.

The server software is written using Extensible Markup Language (XML), which provides for the definition and tagging of data collected by the system. Once the data is tagged, it may be generically requested by other computers also using XML. This is accomplished when a remote requesting computer asks the server 112 to send data associated with a particular tag. The server 112 then retrieves the data associated with the particular tag from the databases 108 and transmits the data to the requesting computer. Once the requesting computer receives the data, it validates and interprets the data to be sure that it is the requested data. By using XML, once a particular piece of information, such as a buyer's home address, is entered into the system, it need not be re-entered, because any program that needs the data in the future may generically request the data from the server.

A. Agent Workspace

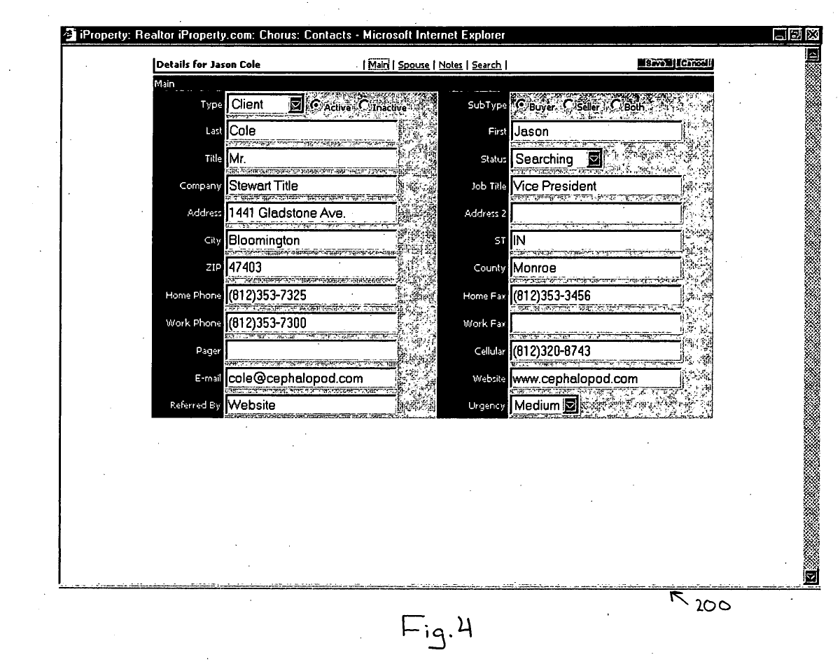

When the agent logs on to the system from one of the remote computers, the agent workspace home page 202 is displayed on the screen of the remote computer, as shown in FIG. 3. The agent uses an interaction device, such as a mouse, to navigate through the workspace by clicking or choosing various options. The agent workspace 200 provides information unique to the particular agent logged onto the system. Although the format of information displayed in any agent workspace 200 is the same, each workspace will contain information unique to the agent and his clients, and thus a unique workspace is provided for each agent.

The agent workspace home page 202 includes a menu 262 providing the agent with a number of different options while working within the workspace. The menu 262 options include the following: transaction, listings, tools, reports and news. The agent may scroll through the options by clicking on the arrows 264 to the right or left of the menu 262.

1. Transaction Menu Option

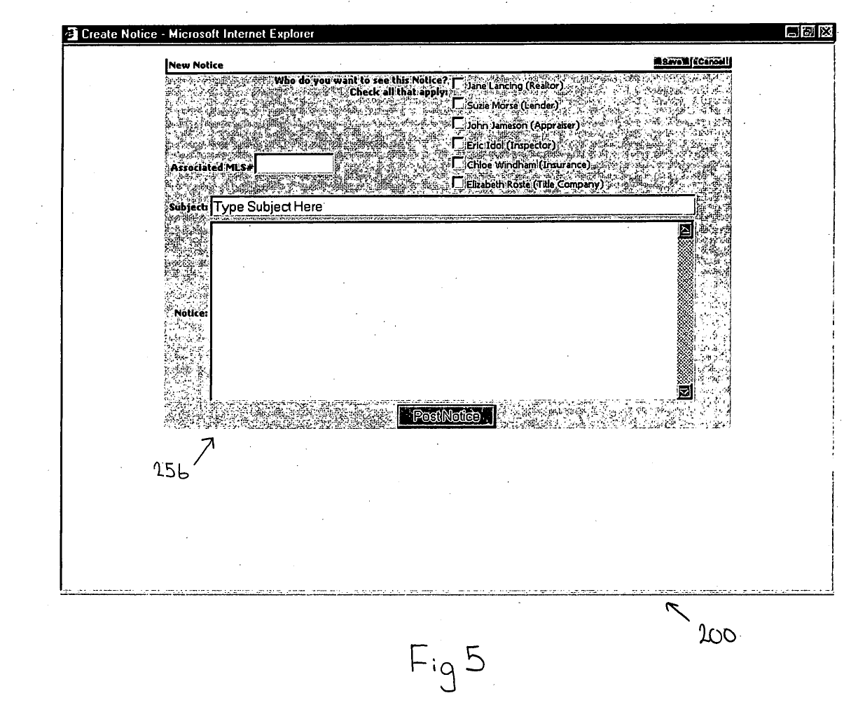

The transaction menu option 203 provides the agent with detailed information about each of the agent's clients. As shown in FIG. 3, the transaction contacts page 204 is the first page displayed under the transaction menu option, but may be viewed at any time by choosing the contacts option 205 under the transaction menu option 203. The transaction contacts page 204 includes a list of the agent's clients or other parties in the center of the screen. The word “contacts” is used herein to refer to the agent's clients as well as other transaction parties using the transaction management system 100. Each contact is associated with a row of information about the particular contact. Various columns indicate particular types of information about the various contacts. The contacts are listed by name in a name column 208, and corresponding addresses and phone numbers are respectively listed in an address column 210 and phone column 212. Icons 220 are provided next to contact names to identify each client as a buyer, seller, both buyer and seller, or prospective client. A legend 221 is provided at the top of the screen to translate the meaning of each icon. Information about the last time a client visited the system is provided under a last visit column 214, and the status of the client's transaction is provided under a status column 216. If the contacts list is exhaustive, the agent may wish to search for a particular contact in the name column. This searching function can be accomplished by entering a contact name in the entry line 224 and clicking the find button 222. The system will then automatically advance to the name entered by the agent. Contacts may also be added to the transaction contact page by clicking on the create new contact option 223. When the create new contact option 223 is selected, a screen appears, as shown in FIG. 4, which allows the agent to enter information about a particular individual and create a new contact.

Notices may be sent directly between the workspaces of parties participating in the transaction. A notice is simply a message communicating some piece of information to another party. With reference again to FIG. 3, a notice table 226 is provided at the left of the icon 220 for each listed contact. The notice table uses dots 229 to indicate whether a new notice has been received from a particular contact, and whether a new notice has been sent to a contact, but has not been opened by the contact. Also, the notice table indicates whether a service order has been recently submitted or whether closing documents have been recently received for a contact when a dot 229 is placed next to the contact name.

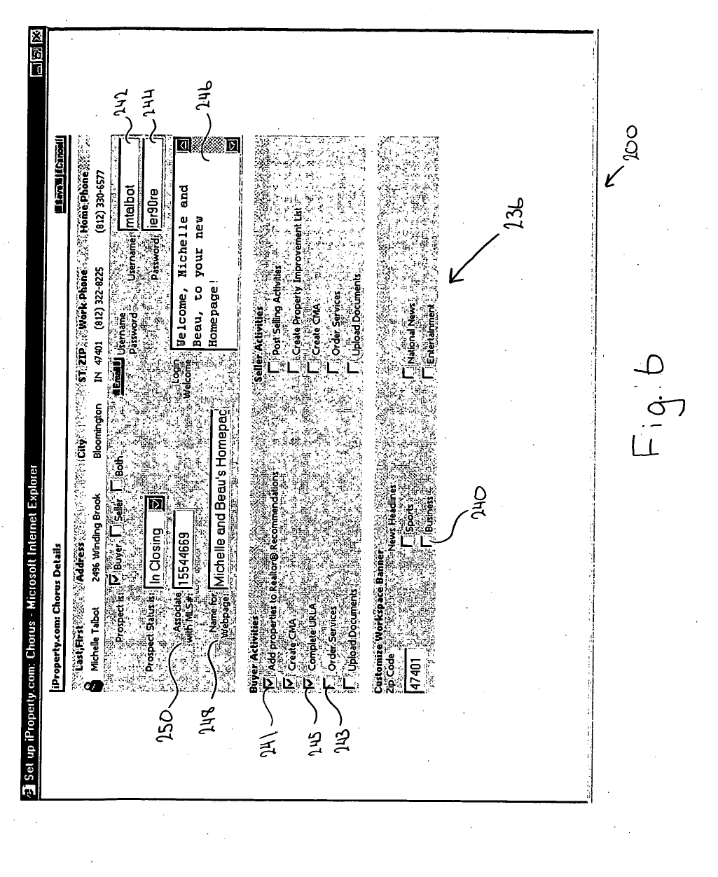

Following the client status column 216, an actions column 218 is provided with four action buttons for each contact. The first button is a notice button 228. By clicking the notice button 228, the agent is able to send messages directly to the workspace of a particular contact also registered to use the system. Notice buttons 228 are either green or blue. Green notice buttons indicate that the button may be used to send a notice to the contact website, i.e., personalized workspace. Blue notice buttons indicate that a website has yet to be created for the contact, and thus notices can not be sent to the contact workspace. When a green notice button is clicked, a notice screen appears allowing the agent to send a notice to the contact shown in the same row as the notice button. As shown in FIG. 5, the notice screen 256 allows the agent to type in a notice and indicate which parties and other service providers involved with the transaction should receive the notice. As mentioned previously, after a notice is sent to a contact, a dot 229 will appear next to the contact name in the notice table 226 shown in FIG. 3 to indicate that a new notice has been sent to the contact.

The second button in the actions column 218 is an e-mail button 230. When this button 230 is clicked, an e-mail message box appears with a blank message directed from the agent to the contact. The agent then enters a message to be sent to the contact's e-mail address. In this manner, the e-mail button 230 creates a second option for communicating electronically with contacts entered into the system. While notices are the preferred method for communicating with contacts, e-mail communication is provided for those contacts that do not have a workspace or otherwise prefer being contacted by e-mail.

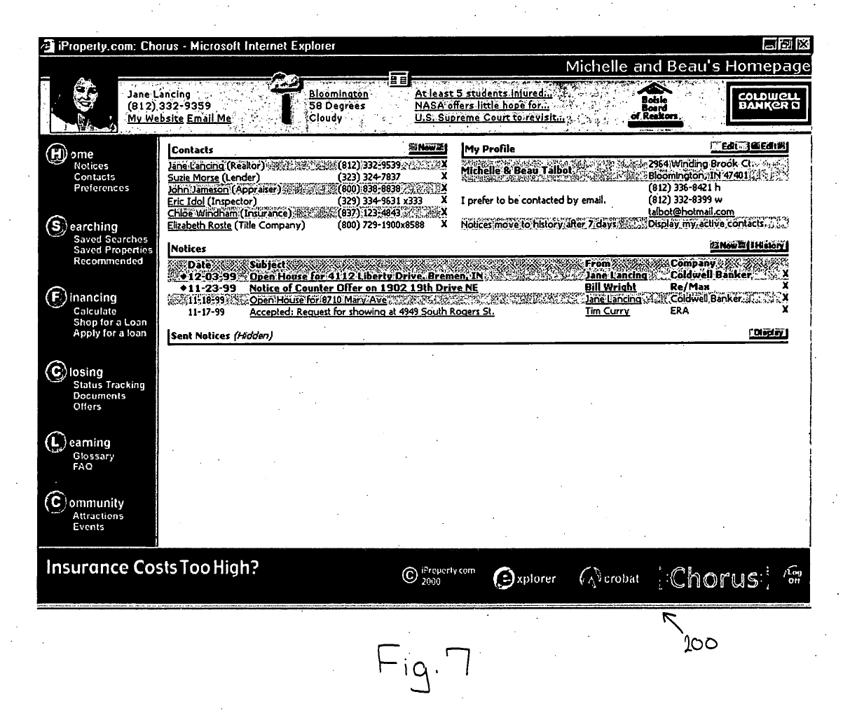

The third button in the status column is a website button 232. Each website button 232 is either green or blue. Blue website buttons indicate that the contact displayed in that row does not currently have a website, i.e., personalized workspace. When blue website buttons are clicked, a website creation page appears, allowing the agent to create a website for the contact. As shown in FIG. 6, the website creation page 236, automatically places relevant identifying information about the contact across the top of the screen. The agent can easily create a website for the contact by simply choosing various options 240 listed on the website creation page 236. For example, if the contact is a buyer, the agent can choose the realtor recommendations option 241 to provide the contact with a website section where specific listings recommended by the agent may be found. Other options examples, include, but are not limited to, the order services option 243 which provides the contact with the ability to order services from third party service providers, and the URLA option 245 which allows the contact to complete a Uniform Residential Loan Application (“URLA”) through the personalized website. News, weather, other links of interest to the particular client may also be specified for display on the contact's website banner. If the contact is a seller, the agent can provide the contact with various website functions, including the option to order services from third party service providers and view documents for closing. In addition, the agent assigns the contact a username 242 and password 244. The agent can also post a website welcome 246 to the contact. The agent also has the ability to name the webpage 248 and, if the contact is a seller, associate the seller with the MLS number 250 of the home being sold by the seller.

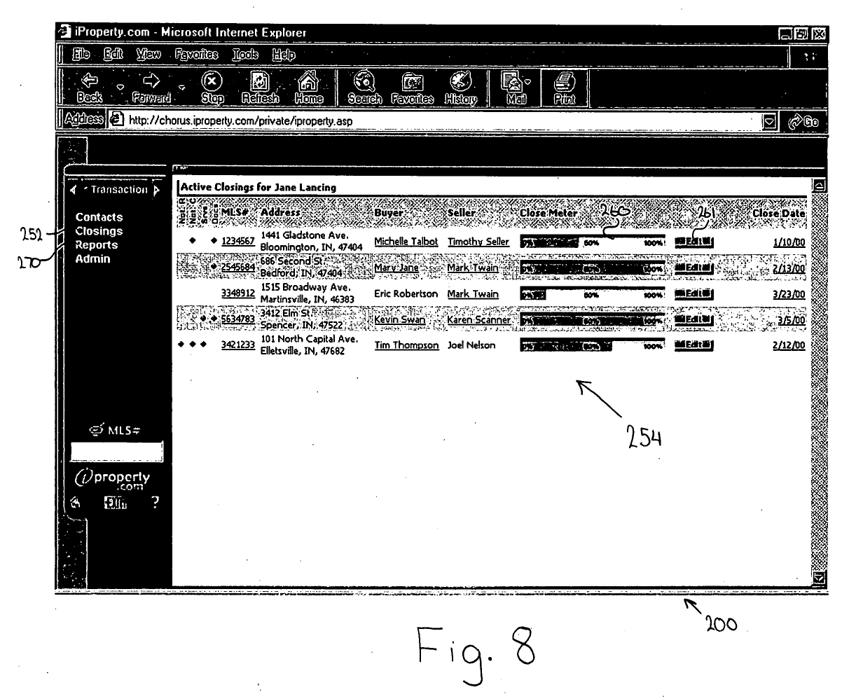

Once the agent creates a website for a contact, the website button will turn green and the agent can view or edit the contact's website by clicking on the website button. An exemplary contact website created by the agent is shown in FIG. 7. Contact websites are explained in more detail, below, under the buyer workspace and seller workspace descriptions. As discussed below, the agent has the ability to enter the contact website after it is created and modify or add certain material to the contact website.

Returning to FIG. 3, the final button of the actions column 218 is the delete button 234. The delete button is used by the agent to remove contacts from the system. An agent may wish to delete a contact from the system upon a contact's request or upon termination of the relationship between the agent and the contact.

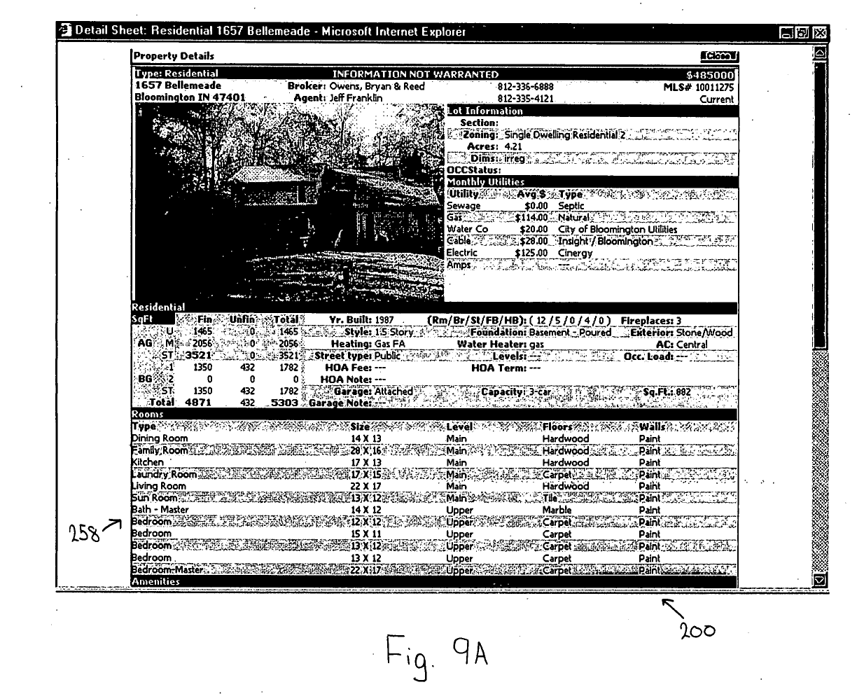

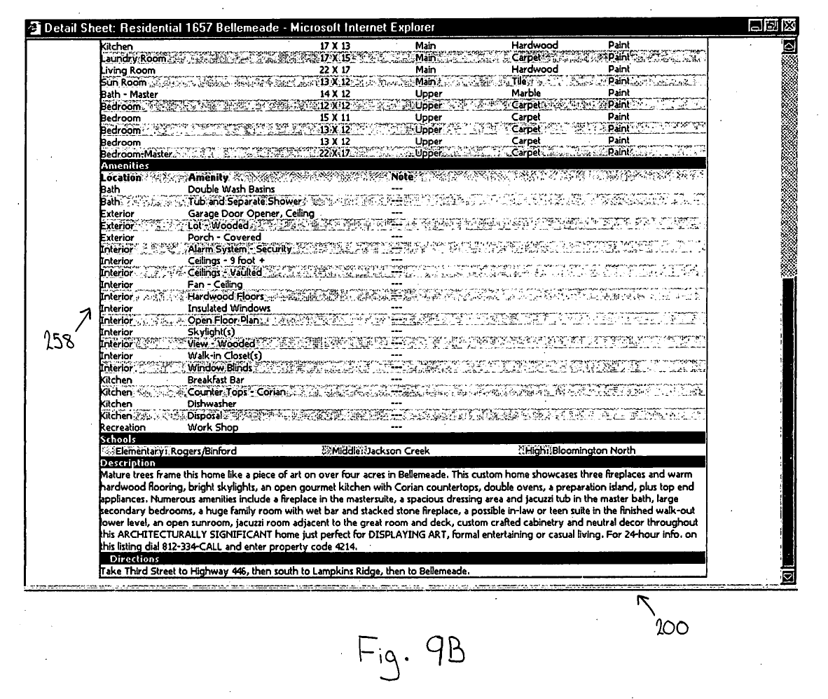

The left side of the transaction contacts screen 204 lists a number of other screens within the agent's workspace that may be easily accessed by the agent from the homepage. By clicking on the closings option 252, the agent may access the transactions closings page 254, shown in FIG. 8. The transactions closings page 254 lists all transactions for the agent where a buyer has made an offer and the seller has accepted the offer, but the deal has not yet closed. The page is organized such that each transaction is placed in a row, and particular pieces of information about the transaction are placed within columns of that row. One column on the transactions closings page 254 identifies each upcoming closing based on the MLS number of the home being sold. Another column on the transactions closings page identifies each home by an address. Yet another column lists the buyer's name while another column lists the seller's name. The final column on the page lists the anticipated closing date of each transaction. If the agent clicks on one of the MLS numbers, the MLS information about the home being sold will be displayed. As shown in FIGS. 9A and 9B, the MLS information 258 includes a home photo as well as a list of other home information, including lot information, monthly utilities, square footage, room information, amenities, schools, text description and directions to the property.

Returning to FIG. 8, a closing meter 260 is associated with each closing identified on the transaction closings page 254. The closing meter 260 is a bar graph that expresses how close the parties are to closing. The closing meter operates by expressing the completed work as a percentage of the total work that needs to be finished before closing. For example, loan approval may constitute 40% of the total work, completion of title documents may constitute 20% of the total work, and completion of the appraisal and the inspection may each constitute 5% of the total work. Thus, when loan approval, title, appraisal and inspection are all complete, the closing meter will read 70%. Completion of other documents will cause the closing meter to read an even higher number. The agent registers various documents as complete within the closing meter by clicking on the edit button 261 next to the closing meter and indicating that a particular document is complete and in order.

In addition to displaying a percentage of work completed toward closing, the closing meter will also indicate if the closing is in jeopardy of not meeting the close date. The normal color of the closing meter is green, but if a document deadline is not met, the closing meter will turn yellow. A yellow closing meter indicates caution, as the closing date is in jeopardy because a closing document has missed a non-critical deadline. For example, if an inspection report is expected to be complete by January 1, but has not been completed by that date, the closing meter will turn yellow to caution the agent that the closing is in jeopardy. The agent can then inspect various transaction documents to discover that the inspection report must be completed by a critical date, such as the closing date, or the deal will not close. If the inspection report is still not completed by the closing date, the closing meter will turn red to indicate that a critical deadline has been missed, and the closing will have to be re-scheduled.

Specific reports and other documents relevant to the transaction may be viewed by the agent by clicking on the reports option 270. The reports option provides a list of documents (not shown) necessary for closing. For example, if the agent wishes to see the home inspection report, he simply clicks on the report option and chooses to view the home inspection report. The home inspection report is then displayed on the agent's remote computer screen for review.

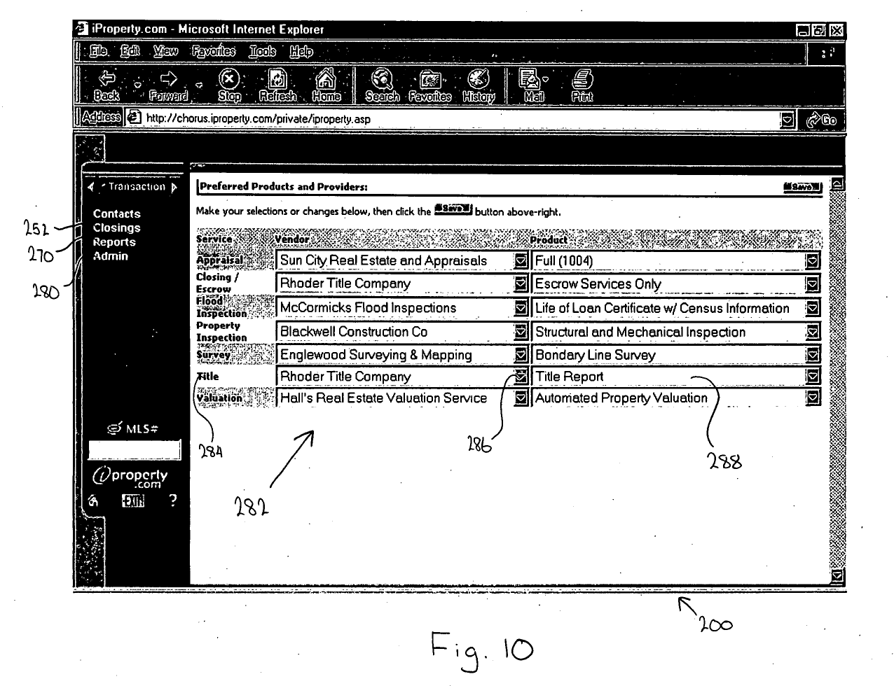

By choosing the administration option 280, the agent can order services through the transaction management system 100. As shown in FIG. 10, the administration screen 282 presents the agent with several pull-down lists of service providers and the products and/or services that they offer. For example, next to the title line 284, one of many different title companies may be chosen by clicking on the down arrow 286 and choosing one of the title companies. After choosing a title company, one of a number of services such as a title report or a foreclosure search may be chosen from the pull-down list 288 next to the chosen service provider. Once the desired service providers and related products and/or services are chosen and saved, the system automatically contacts the chosen service providers by sending each service provider a notice on the service provider's workspace, requesting that the service provider perform the requested services. The notice sent to the service provider allows the service provider to accept or decline the work request. When a service provider accepts or declines a request to complete services, the agent and other relevant parties to the transaction are notified of such acceptance or denial through a notice that appears on both the agent and other party workspaces. If a service provider declines a request to complete services, the agent must return to the administration page 282 and request the service from another service provider.

2. Listings Menu Option

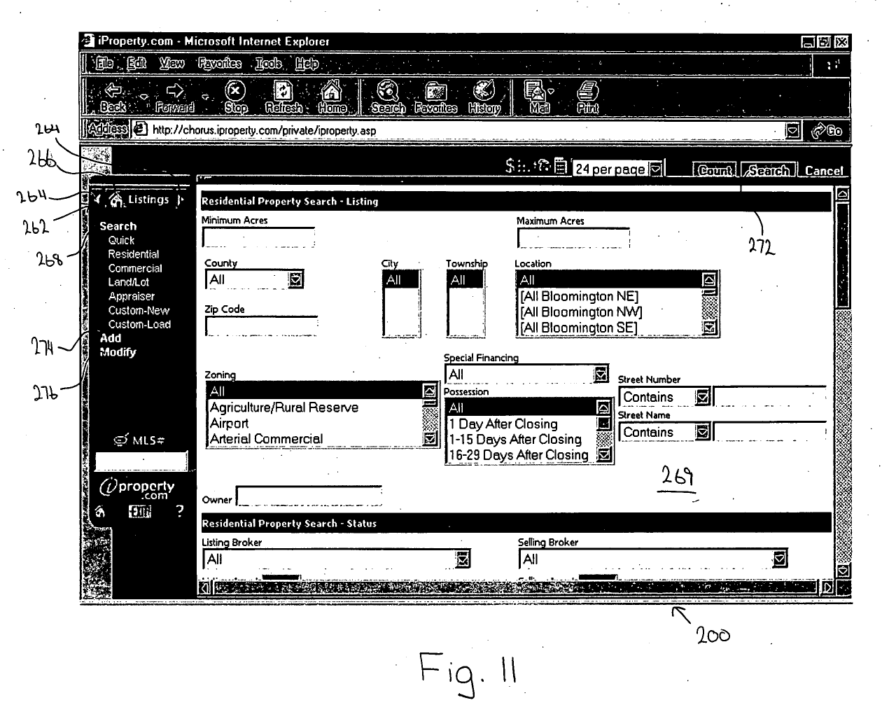

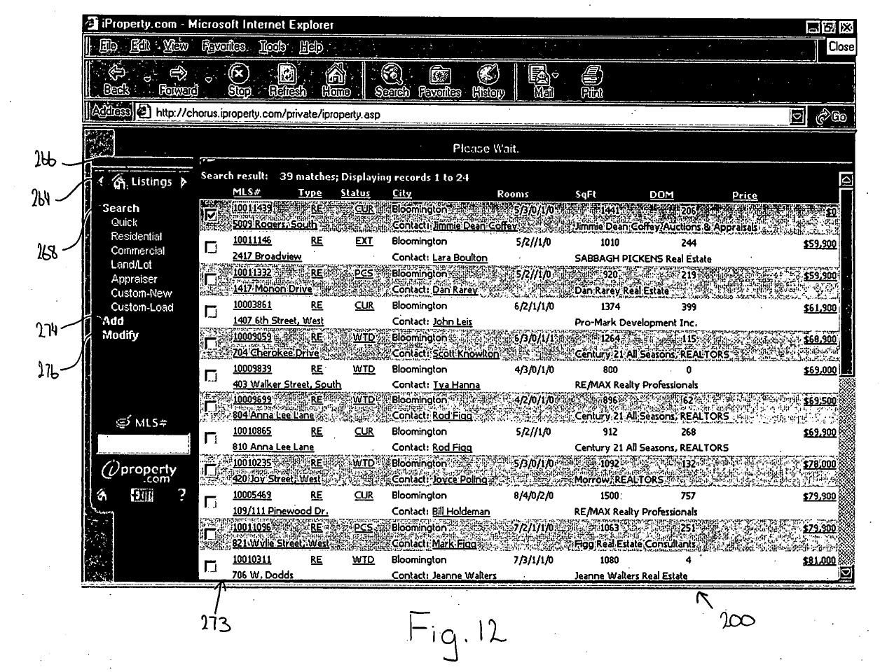

As shown in FIG. 11, by clicking an arrow 264 on the menu 262, the agent may view the listings menu option 266. The listings menu option 266 provides the agent with the ability to search an MLS database for various home listings that may be of interest to clients. The agent may request a number of different search types under the search option 268. After choosing the search option 268, a search page appears, and the agent is presented with a search form to complete. The search may be based upon a number of different criteria, depending upon what information is completed in the search form. A portion of an exemplary search page and search form is shown in FIG. 11. The search form includes various search criteria that may be entered in the search form, including location, price, number of bedrooms, number of bathrooms, basement, and exterior. After the desired search parameters are entered, the agent may click the search button 272 to request the system to conduct the search. After a search is conducted, the system returns a listing of homes. An exemplary list of homes 273 returned from a search is shown in FIG. 12. The agent may view a full listing for any particular home listed by clicking on the MLS number or street address associated with a home on the list 273. A full listing displays home information similar to that shown in FIGS. 9A and 9B.

The listings menu option 266 also allows agents to add homes to the MLS database or modify listings within the MLS database. In order to add a listing, the agent clicks the add option 274 and completes an on-line form (not shown) which requests detailed information about the property being entered into the database. Similarly, to modify a listing, the agent clicks the modify option 276 and modifies the form to reflect the most up to date information on the property being offered for sale. The transaction management system 100 will restrict an agent from modifying information about a property if he is not the same agent that originally entered information about that property.

3. Tools Menu Option

By clicking the arrow 264 again, the agent may view the tools menu option (not shown). The tools menu option provides the agent with a number of useful tools within his workspace. One tool provided under the tools menu option is a pre-qualification calculator. The pre-qualification calculator requires the agent to enter information about a client to determine if the client meets the minimum qualifications to purchase a property in a particular price range. This tool will assist the agent in focusing the client on affordable housing options rather than wasting time looking for houses that are outside of the client's spending limits. The tools menu also provides the agent with a mortgage calculator. The mortgage calculator requires the agent to input information about a particular house of interest to a client, as well as information other financial information such as down-payment amount and interest rate. With the information entered into the mortgage calculator, the agent can predict the monthly payment on a particular house of interest to a client.

Board forms are also offered to the agent under the tools option menu. By clicking on the board forms option, the agent will be presented with a number of standardized forms that may be used by the agent during the transaction. Forms offered under the board forms option include offers to purchase, counter-offers, escrow agreements, and purchaser's inspection authorization. The agent may click on a particular form of interest from the list of standardized forms (not shown), and the form will be displayed on the agent's workspace 200. Once the form is displayed, a number of form fields will be blank. For example, if the agent is completing an offer to purchase, the buyers name field and address field remain blank. The agent completes the form by entering information in the fields. Once the agent identifies enough relevant pieces of information in the form fields to identify the buyer, the system automatically retrieves information for completion of other fields from the transactions database. For example, once the buyer's name is entered on the form, the buyer's address is automatically be entered on the form. Of course, not all form fields will be completed with information stored in the transaction database. The offer to purchase form includes a field for an offer amount, and the system will not automatically enter the offer amount because it has not previously been entered into the system. Because of the automatic form completion feature, the system saves the agent a great deal of time when completing forms for the transaction. After completing the form, the form is associated with the particular transaction and may be periodically viewed by the parties to the transaction along with other closing documents as described herein.

In addition to the above, the tools option provides the agent with a number of other resources, such as an option to view a user manual or other system documentation or the option to change the agent's password.

4. Reports Menu Option

Another click of the arrow 264 brings the agent to the reports menu option (not shown). The reports menu option provides the agent with the ability to generate a number of different types of reports. Reports provide lists of data in spreadsheet form on large numbers of properties. A report is distinct from a search conducted under the listings option because a search supplies actual listing information along with property photos. A report, on the other hand, provides only basic information on a larger number of properties. A number of different reports are possible under the reports menu. For example, a hot list provides a view of recent changes in the market place such as new listings, sold listings, expired listings, withdrawn listings or pending listings. Other examples of reports include residential or commercial property reports by listing agent, or a market share analysis which provides information on a particular firm or agent's sales.

5. News Menu Option

A final click of the arrow 264 brings the agent to the news menu option (not shown). The news menu option provides the agent with links to a number of different news websites which the agent may wish to access from within his webspace. These links may include national news, sports news, weather news, local news, or any other websites of interest to the agent.

Thus, as described above, the agent workspace 200 provides the agent with the ability to manage the complete real estate transaction from a single location. By using the real estate transaction management system, the agent has the ability to easily communicate with contacts, create and edit contact workspaces, monitor progress of the transaction toward closing, and order products and services required for closing from third party service providers.

B. Buyer Workspace

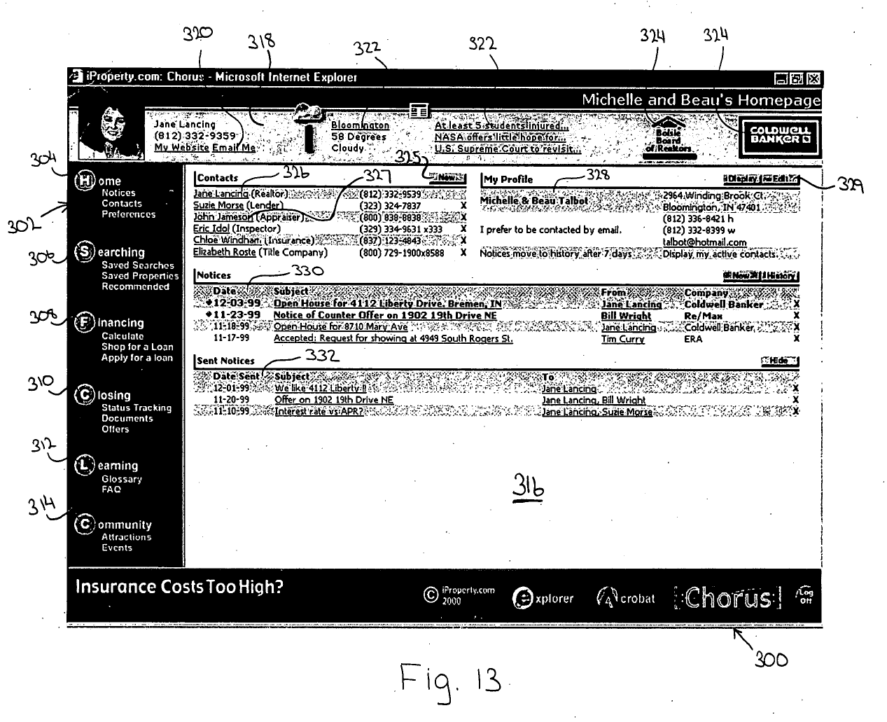

As discussed above, the transaction management system 100 allows agents to create workspaces for their clients. After an agent creates such a client workspace, he contacts the client to provide the client with username and password information that will provide the client with access to his personalized workspace. An exemplary buyer workspace 300 is shown in FIG. 13. A menu 302 is displayed for the buyer workspace on the left side of the workspace. The menu 302 includes the following options: home option 304, searching option 306, financing option 308, closing option 310, learning option 312, and community option 314.

1. Home Option

The home option 304 brings the buyer to the home page 316 for the buyer-workspace 300. This is the first page that is presented to the buyer upon entering his username and password. As shown in FIG. 13, the home page 316 includes a top banner 318 that displays information about the buyer's agent including name, phone number, and links to the agent's website and e-mail 320. The top banner also provides the buyer with news headlines and links to various websites 322. For example, the top banner may include weather information, news information and related links. In addition, advertisements 324 for various service providers may be listed across the top banner.

The content of the buyer home page 316 includes a list of buyer contacts 326, a buyer profile 328, a list of notices recently received 330, and a list of notices recently sent 332. The list of buyer contacts 326 includes the name and phone number of any party to the transaction that the buyer may need to contact. By clicking on the name of the contact 327, the buyer may send a notice to the contact. For example, if the buyer wishes to check on the status of an appraisal, he simply clicks on the appraiser's name 327 and sends a notice to the appraiser requesting about the appraisal status. If the buyer wishes to add a new contact, he may click on the button labeled “new” 325 above the list of buyer contacts.

The buyer profile 328 is displayed across from the contacts 326. The buyer profile lists the buyer's name, address, phone numbers, e-mail, and relevant options. For example, the buyer profile 328 shown in FIG. 13 indicates that the buyer wishes to be contacted by e-mail instead of by notices sent to the buyer's workspace. The buyer may edit his profile by clicking on the “edit” button 329 above the buyer profile 328. When editing the buyer profile 328, the buyer may choose to limit agent access to various pages of the buyer workspace. For example, the buyer may restrict the agent from viewing buyer financial documents.

The list of notices recently received 330 and recently sent 332 are listed below the buyer contacts on the buyer home page 316. The notices indicate the date the notice was sent or received, the subject of the notice, and the sender or recipient of the notice. In order to view a particular notice, the buyer simply clicks on the subject of the listed notice and the full message is displayed. For example, if the appraiser has sent a notice to the buyer indicating that an appraisal has been recently conducted, the buyer may view the notice by clicking on the subject line of the notice sent from the appraiser.

2. Searching Option

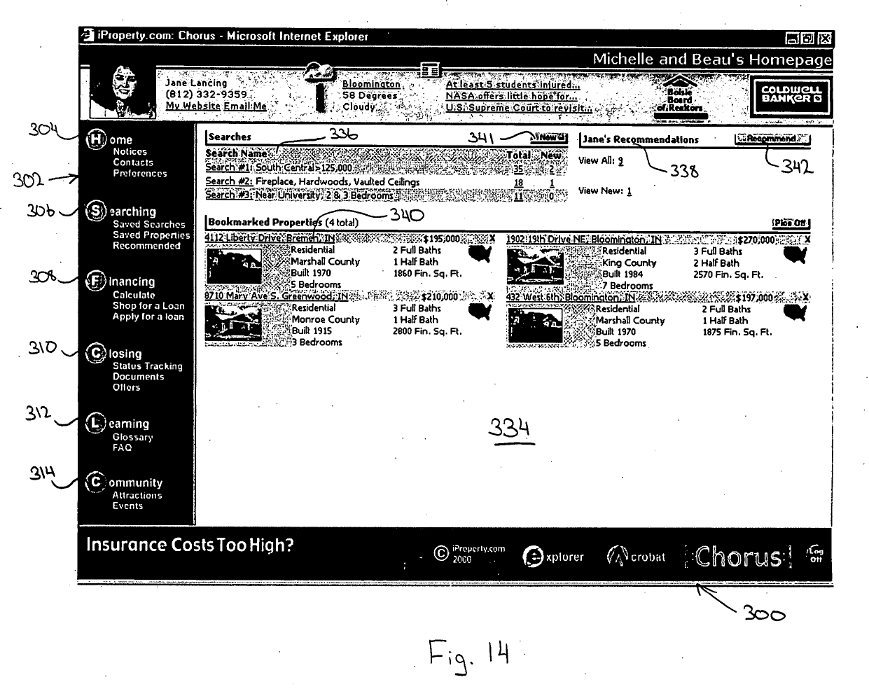

The buyer may click on the searching option 306 on the menu 302 to bring the buyer to the search page. As shown in FIG. 14, the search page 334 includes a list of saved searches 336, agent recommendations 338, and bookmarked properties 340. A buyer may search the listings database for new searches by clicking the “new” button 341 above the list of saved searches. When this button 341 is clicked, the buyer is provided with a search request (not shown) where a number of different search criteria may be specified. For example, the buyer may search in a particular township for homes in a particular price range with a brick exterior. After all search criteria are specified, the system searches the listings database for all homes meeting the defined criteria, and returns a list of those properties. The list of properties returned to the buyer allows the buyer to view detailed information about any home in the search, similar to the information shown in FIGS. 9A and 9B. These searches may then be saved by the buyer for subsequent viewing. FIG. 14 shows three saved searches 336. To view the list of homes returned from a particular saved search 336, the buyer simply clicks on the search he wishes to see.

In addition to searching the listings database, the buyer may view listings recommended by the buyer's agent under the agent recommendations list 338. The buyer may view all homes recommended by the agent or only the new recommendations not previously viewed by the buyer. Again, a detailed listing of information similar to that shown in FIGS. 9A and 9B is available to the buyer by choosing to view in depth information about an agent recommended home. Agents recommend homes to buyers by visiting the buyer's website and clicking on the recommend button 342 and entering the MLS number of a home they wish to recommend to the particular buyer. The recommend button 342 may only be chosen by the agent upon viewing a buyer website, and may not be chosen by buyers visiting their own workspace. Thus, in order to signal that the recommend button 342 is not available to buyers, it is colored differently from other options and buttons available to buyers within their own workspace.

When a buyer sees a property of particular interest, the buyer may bookmark the property. Bookmarked properties are those properties which the buyer wishes to have easy access to for future viewing. To this end a bookmark option (not shown) is generally available to the buyer when viewing information about particular properties of interest. The bookmark option is generally a button included on a full listings page, such as the listing shown in FIGS. 9A and 9B. Once a property is bookmarked, a mini-listing for the property is shown under the bookmarked properties 340 on the buyer's search page 334. Bookmarked properties allow buyers to easily access information about particular properties of interest. A fu 11 listing of information about a bookmarked property is available from the buyer's search page 334 by clicking on the property.

3. Financing Option

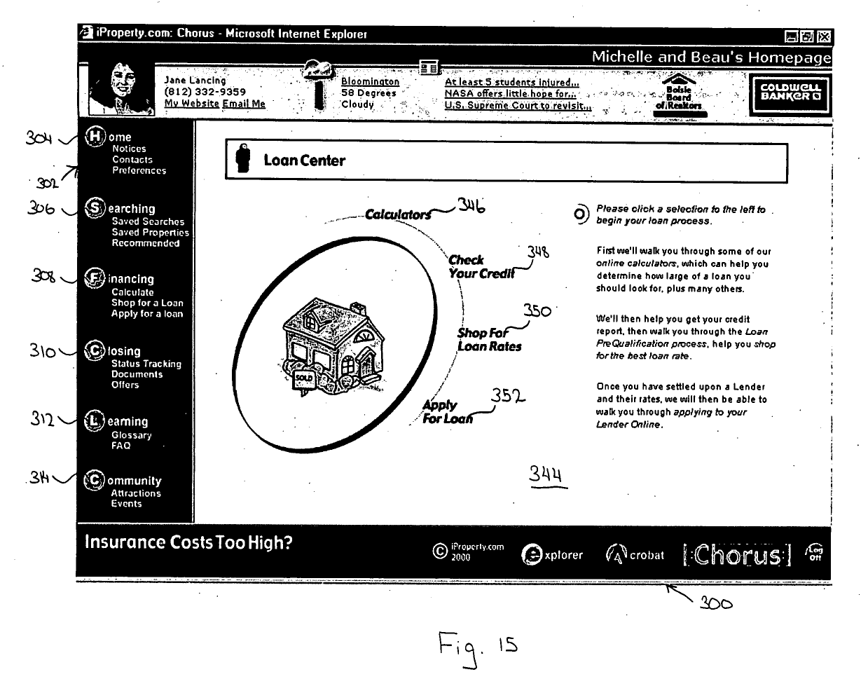

The buyer may click on the financing option 308 from the buyer workspace 300 to access the financing page 344. As shown in FIG. 15, the financing page 344 offers the buyer a number of services, including options to use various calculators 346, credit check services 348, loan shopping services 350 and loan application services 352. By choosing to access the calculators 346, the buyer can make various calculations, including an estimation of monthly mortgage payments for a particular home of interest, and a determination of the benefits of buying a home vs. renting.

The credit check services option 348 links the buyer to a credit reporting agency's website. After the buyer completes an on-line form provided by the credit reporting agency, the credit reporting agency will provide the buyer's credit report to the buyer or forward the report to a particular lender specified by the buyer.

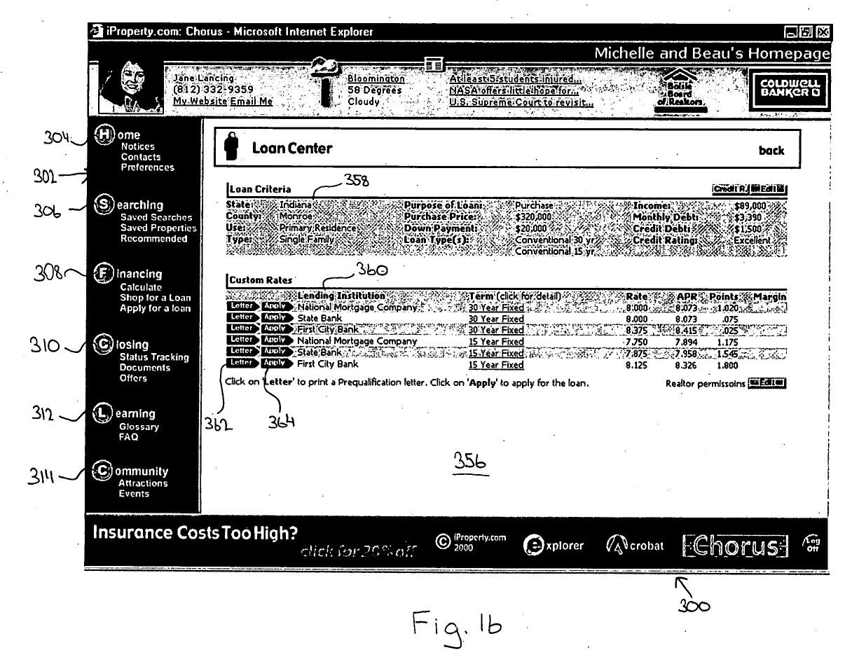

If the buyer chooses the loan shopping services 350 option, he is presented with a pre-qualification form to complete. The pre-qualification form asks the buyer a number of questions necessary to determine which loan products the buyer is qualified to receive. After completing the form, the buyer is presented with a loan products page which lists various loan products and rates available to the buyer by various financial institutions. An exemplary loan products page 356 is shown in FIG. 16. The loan products page 356 includes a listing of the loan criteria 358 entered by the buyer. Beneath the loan criteria 358 is a list of loan products 360 available to the buyer. Each loan product listed includes the name of the lending institution as well as the term of the loan, the interest rate, the annual percentage rate, and the points required. Of course, all loan products available to the buyer are subject to the accuracy of the information entered by the buyer during the pre-qualification process. Next to each loan product listed is a “letter” option 362 and an “apply” option 364. If the buyer chooses the letter option 362, a pre-qualification letter will be displayed. This letter may be printed or sent to the buyer's agent to certify that the buyer is qualified to purchase a home in a particular price range.

After the buyer decides that he wishes to officially apply for one of the loans on the loan products list 360, the apply option 364 is chosen from the loan products page 356. By choosing the apply option 364, the buyer is presented with an on-line version of the Uniform Residential Loan Application (URLA). The buyer may also access the URLA by choosing the apply for loan option 352 directly from the financing page 344 shown in FIG. 15. Because the system operates using XML, certain pieces of information about the buyer already stored in the system, such as name, address, and phone number, are automatically downloaded into the loan application. This saves the applicant a great deal of time when completing a loan application, or any other form, using the system. Once the loan application form is completed, it is forwarded to the lender from whom the buyer is requesting a loan. The buyer is then notified by notice or e-mail when the lender approves or rejects the loan application.

4. Closing Option

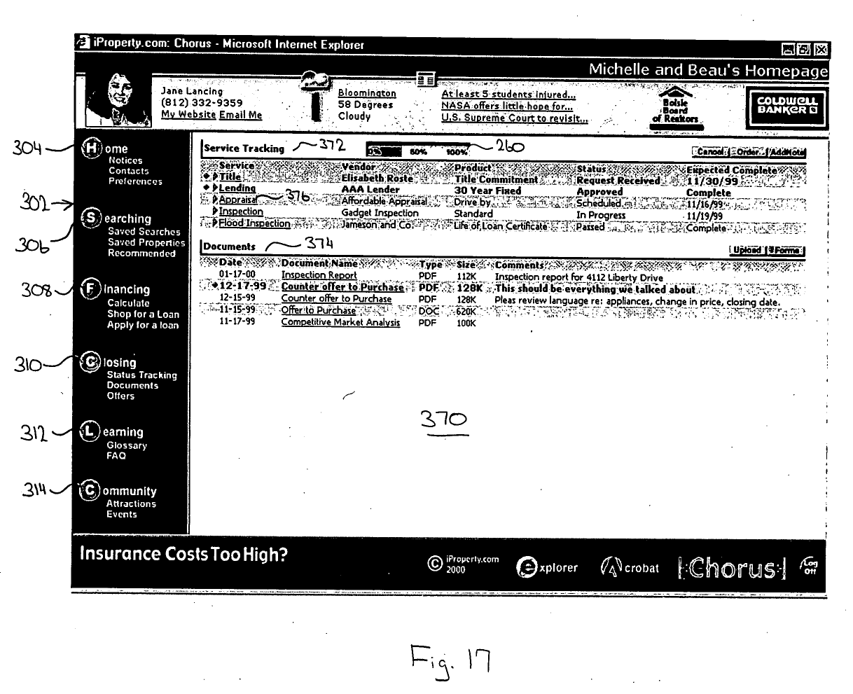

When a buyer has made an offer on a home and the seller has accepted the offer, the buyer may click on the closing option 310 from the menu 302 to access the closing page 370 and track the status of documents required for closing. As shown in FIG. 17, the closing page 370 includes a service tracking block 372 which provides a list of services that have been ordered for closing and the status of the service requests. The service tracking block 372 lists the particular service requested, the vendor, the status of the request, and the expected completion date of the service. If the buyer is interested in additional information about a particular service requested, he may click on the service to receive additional information. For example, by clicking on the Appraisal service 376, information is provided about when the service was requested, when the service request was accepted, and when the service was scheduled for completion. In this manner, the service tracking block 372 provides the buyer with the ability to monitor services required before closing and determine if any potential barriers to closing arise. To assist the buyer in monitoring services, the closing status meter 260, identical to the closing status meter provided for the buyer's agent, is also provided for the buyer above the service tracking block 372.

Particular documents required for closing are listed under a documents block 374 of the closings page 370. The documents block 374 lists all documents that are complete and ready to be presented at closing. The buyer may view any of these documents by simply clicking on the document listed.

5. Learning Option

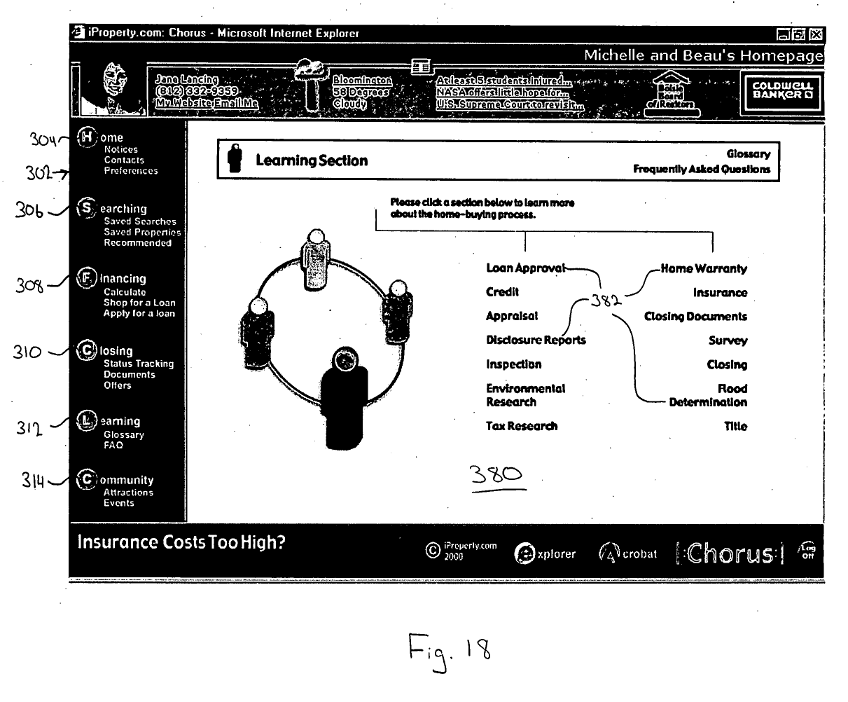

By choosing the learning option 312 from the menu 302, the buyer is presented the learning page 380. As shown in FIG. 18, the learning page 380 provides a number of links 382 to educational resources about the real estate transaction. By clicking a particular link, the buyer is provided with information about various topics related to the home buying process. Topics include loan approval, credit, appraisal, disclosure reports, inspection, environmental research, tax research, home warranty, insurance, closing documents, survey, closing, flood determination, and title.

6. Community Option

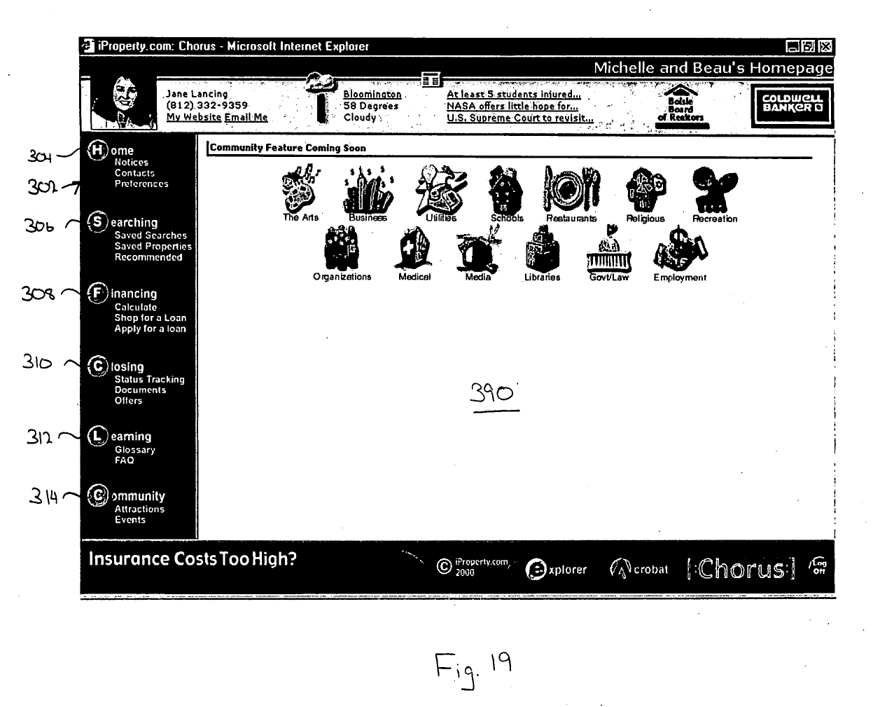

By choosing the community option 314 from the menu 302, the buyer is presented the community page 390. As shown in FIG. 19, the community page links the buyer to a number of valuable research tools for studying the community where a particular property of interest is located. The community page provides information and links to various other sites allowing the buyer to find out information about the arts, businesses, utilities, schools, restaurants, religious organizations, recreational attractions, community organizations, medical facilities, local media, libraries, government and employment opportunities for a particular community.

In summary, the buyer workspace presents the buyer with a one-stop shopping experience when purchasing a new home. By logging on to a single remote computer, the buyer is able to contact other parties to a transaction, search for properties of interest, obtain financing information and apply for a loan, track and review all documents required for closing, and learn more about the home buying process and a particular community of interest to the buyer.

C. Seller Workspace

As discussed above, the transaction management system 100 allows agents to create workspaces for their clients. When the agent creates the seller workspace, he enters information about the particular property which the seller is selling into the listings database. When the property is entered into the listings database, it is assigned an identification number, or MLS number, which is used to track activity related to the property. After an agent creates such a client workspace, he contacts the client to provide the client with username and password information that will provide the client with access to his personalized workspace.

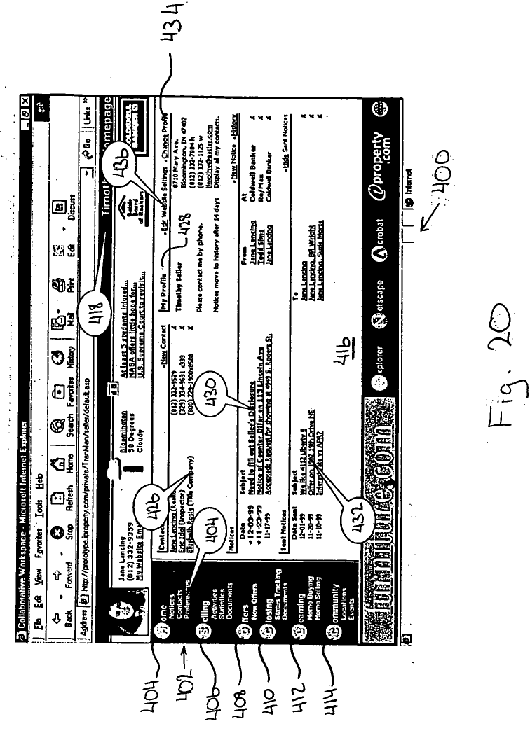

An exemplary seller workspace 400 is shown in FIG. 20. A menu 402 is displayed for the buyer workspace on the left side of the home page. The menu 402 includes the following options: home option 404, selling option 406, offers option 408, closing option 410, learning option 412, and community option 414.

1. Home Option

Upon entering a username and password, the seller is automatically directed to a seller home page 416. The seller home page 416 is arranged very similar to the buyer home page 316. A top banner 418 provides the seller with information about the seller's agent, news information and links, and advertisements. A list of seller contacts 426 is provided under the top banner. Similar to the buyer home page, if the seller wishes to send a notice to any of the contacts, he simply clicks on the contact name, and a notice box appears allowing the seller to draft a notice to the addressee.

Next to the seller contacts 426, the seller's profile 428 is displayed. If the seller wishes to revise his profile, the “change profile” button 434 is clicked, and the seller may edit his personal profile stored in the databases 108. Also, if the seller wishes to revise options related to the set-up of his workspace, the seller may click on the “edit website settings” button 436 and change various seller workspace settings, such as favorite news links.

Under the seller contacts list 426, a list of recently received notices 430 and sent notices 432 is displayed. If the seller sees that a new notice has been received, he simply clicks on the listed notice subject and the full notice is displayed in a pop-up box. Likewise, if the seller wishes to see a sent notice, he may click on the notice subject and review the notice already sent to a third party. With these options, the system provides the seller with a convenient device for communicating with other parties to the transaction.

2. Selling Option

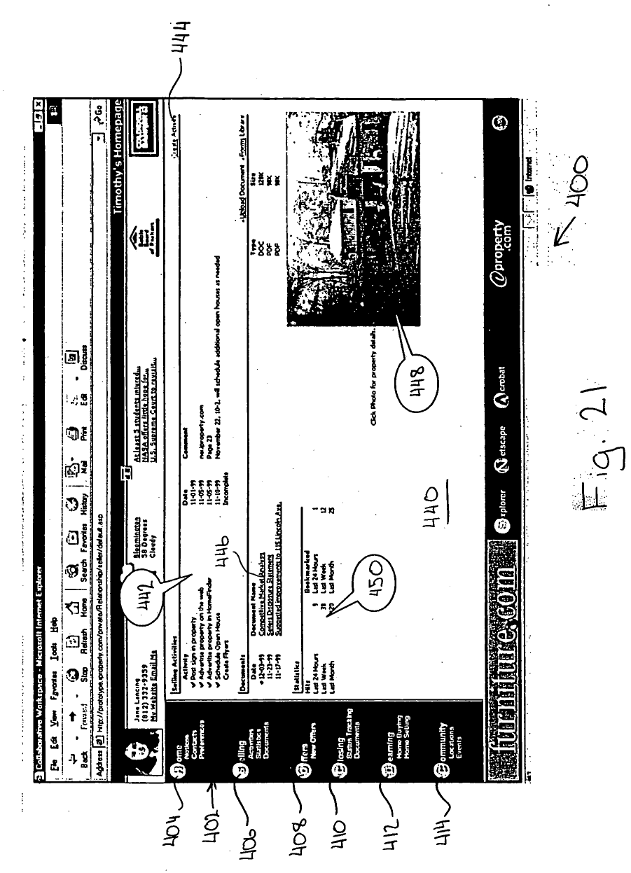

By clicking on the selling option 406 from the menu 402, the seller is taken to the selling page. An exemplary selling page 440 is shown in FIG. 21. The selling page provides a list of selling activities 442 for the seller to complete. For example, the selling activities may include posting a “for sale” sign on the property, scheduling an open house, and creating flyers for distribution. The date of each completed task is noted along with any comments related to the task. The seller may create additional tasks by clicking on the create activity option 444. The agent may also create additional tasks by entering the seller workspace 400 and choosing the create activity option 44. As mentioned previously, the agent may enter the seller workspace 400 through the agent workspace 200 by clicking on the website button 232. Once inside of the seller workspace, the agent is provided with limited editing powers, such as creating selling activities.

To the bottom right of the selling page 440, a photo 448 of the property for sale by the seller is shown. By clicking on the photo 448, the seller may view a full listing of the property, as seen by buyers when they view information about the property.

Under the selling activities, various selling documents 446 are listed. Selling documents include required documents, such as the seller's disclosure statement, as well as other optional documents created by the agent or a third party, such as a competitive market analysis. Any of the listed documents may be viewed by clicking on the document.

Below the selling documents 446, selling statistics 450 are provided related to the property for sale by the seller. Specifically, the seller can view the number of searches conducted by buyers where the search returned the seller's property as a hit. These statistics are provided for hits within the last 24 hours, the last week, and the last month. In addition, the selling statistics 450 include information about the number of buyers who have bookmarked the property within their personal workspaces. As discussed previously, buyers may bookmark properties of particular interest such that a mini-listing of the property is shown on the buyer search page 334 of FIG. 14. Statistical information about bookmarks is provided for bookmarks made within the last 24 hours, the last week, and the last month. This statistical information can be very valuable to a seller because it provides the seller with information about the level of buyer interest in the seller's property. If a large number of buyers have bookmarked the property, buyer interest is very high, and the seller can negotiate from a stronger position than if the interest in the property is low.

3. Offers option

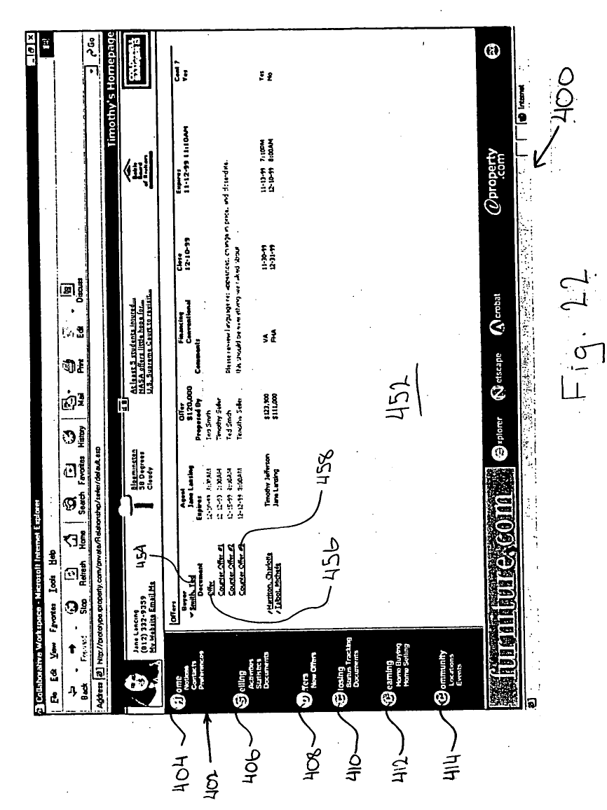

By clicking on the offers option 408 from the menu 402, the seller is presented with the seller offers page. An exemplary seller offers page 452 is shown in FIG. 22. As discussed previously, buyers may forward offers to the seller using their agents. These offers and any subsequent counter-offers made by the seller are listed on the offers page 452. Offers are listed by buyer name 454. If a seller wishes to see a current or past offer or counter-offer during the negotiations process with a particular buyer, he simply clicks on the buyer name 454 to reveal the full list of offers 456 and counter-offers 458 for that buyer. If the seller then clicks on the particular offer or counter offer he wishes to see, the document is provided to the seller as a pop-up screen on the offers page 452.

4. Closings Option

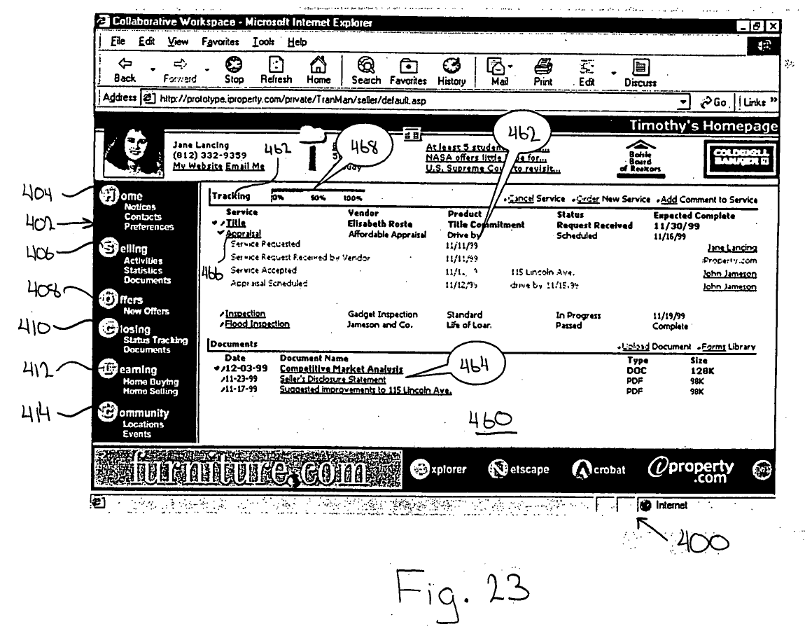

When the seller accepts one of the buyer's offers, the transaction is ready to move forward toward closing. The seller may click on the closing option 410 from the menu 402 to access the closing page 460 and track the status of documents required for closing. The seller's closing page 460 is shown in FIG. 23. The seller's closing page is very similar to the buyer's closing page 370 shown in FIG. 17, with the exception that the seller's closing page 460 does not include lending information, which is confidential to the buyer.

The seller's closing page 460 includes a service tracking block 462 which lists services that have been ordered for closing and the status of the service requests. The service tracking block 462 shows particular services 466 requested for closing, vendors, the status of each requested service, and the expected completion date of each service. If the seller is interested in additional information about a particular service requested, he may click on the service 466 to receive additional information, such as date of service request and date of acceptance of request. The service tracking block 462 provides the buyer with the ability to monitor services required before closing and determine if any potential barriers to closing arise. To this end, a closing status meter 468, identical to the closing status meter provided for the agent and the buyer is also provided for the seller above the service tracking block 462.

Particular documents required for closing are listed under a documents block 464 of the closings page 460. The documents block 464 lists all documents that are complete and ready to be presented at closing. The seller may view any of these documents by simply clicking on the document listed.

5. Learning Option

By choosing the learning option 412 from the menu 402, the seller is presented the learning page, identical to the buyer's learning page 380 shown in FIG. 17. The learning page provides a number of educational resources about the real estate transaction. By clicking a particular topic, the seller may learn more about the home buying process. Topics include loan approval, credit, appraisal, disclosure reports, inspection, environmental research, tax research, home warranty, insurance, closing documents, survey, closing, flood determination, and title.

6. Community Option

By choosing the community option 414 from the menu 402, the seller is presented the community page 390, identical to the buyer's community page, as shown in FIG. 18. The community page links the seller to a number of valuable research tools for studying the community where a particular property of interest is located. The community page provides information and links to various other sites allowing the buyer to find out information about the arts, businesses, utilities, schools, restaurants, religious organizations, recreational attractions, community organizations, medical facilities, local media, libraries, government and employment opportunities for a particular community.

D. Service Provider Workspace

In addition to the agent, buyer, and seller, various service providers may register to use the system. Service providers may include, but are not limited to, financial institutions, inspectors, appraisers, title agents, escrow agents, and insurance agents. Service providers wishing to use the system must register with a system administrator. Upon acceptance of a service provider's registration request, the system administrator creates a personalized workspace for the service provider. The service provider is then provided with a username and password which provides the service provider with access to the workspace.

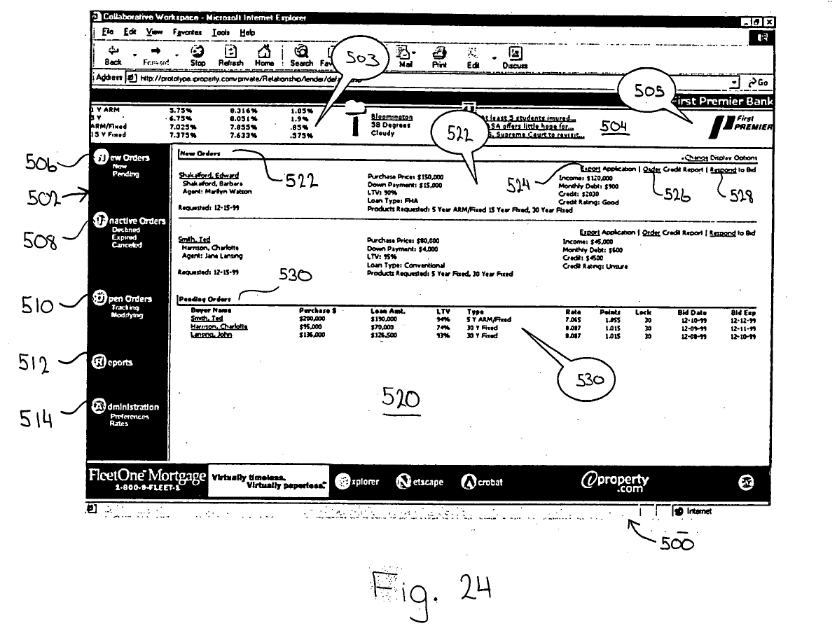

The exemplary service provider workspace 500 shown in FIG. 24 is a lender workspace. All service provider workspaces 500 include a top banner 504 and menu 502 to the left of the workspace. The banner 504 of the lender workspace 500 includes the lender's current rates 503 as well as other information, including links to various news sources and the lender's logo. The lender workspace is somewhat more complex than other service provider workspaces. Thus, the lender workspace is described first herein and a brief discussion of the typical workspace for other service providers follows.

1. New Orders Option

After logging on to the lender workspace 500 and clicking on the new orders option 506, lenders are taken to the new orders page 520. The new orders page 520 provides information to the lender about new loan applications requested by a buyer/applicant. As shown in FIG. 24, new loan applications are listed under the new orders block 522. The new orders block 522 lists a summary of important information about each new applicant, such as name, purchase price, down payment, and loan product requested. For each new applicant listed, the lender may choose the export application option 524, which allows the lender to view the URLA completed by the applicant and deliver the URLA to other interested parties, such as the underwriter. The lender may also choose to order the applicant's credit report by choosing the credit report option 526. This option 526 links the lender to a credit reporting agency website. Lenders are authorized to obtain a the applicant's credit report when the applicant applies for a loan from the lender. After the lender obtains the credit report, it is delivered to an underwriter along with other documents provided by the loan applicant, such as proof of income and the URLA. After the underwriter approves or rejects the loan, the lender may choose the respond to bid option 528 to send a notice to the applicant, informing the applicant that his loan application has been accepted or rejected.

When a loan application has been accepted, but the loan is yet to close, it is listed under the pending orders block 530. By choosing an applicant's name under the pending orders block 530, more detailed information about the pending loan is displayed.

2. Inactive Orders Option

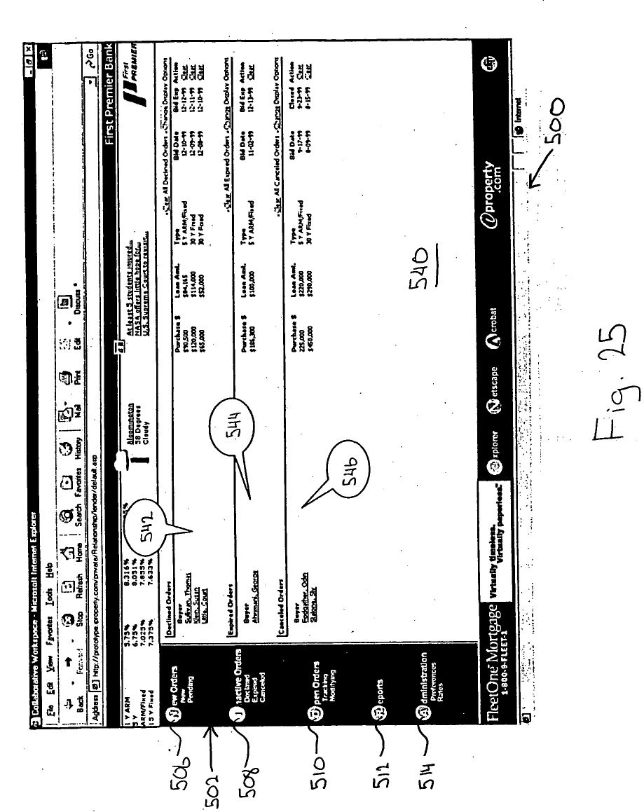

By clicking on the inactive orders option 508 from the menu 502, the lender is presented with an inactive orders page 540. As shown in FIG. 25, the inactive orders page 540 lists declined orders 542, expired orders 544, and canceled orders 546. Declined orders 542 are those applications which have not been awarded loans because the lender has rejected the application for various reasons. Expired orders 544 are those applications which have not been awarded a loan because the applicant failed to provide required information within a prescribed amount of time. Canceled orders 546 are those applications which the applicant has canceled before closing.

3. Open Orders Option

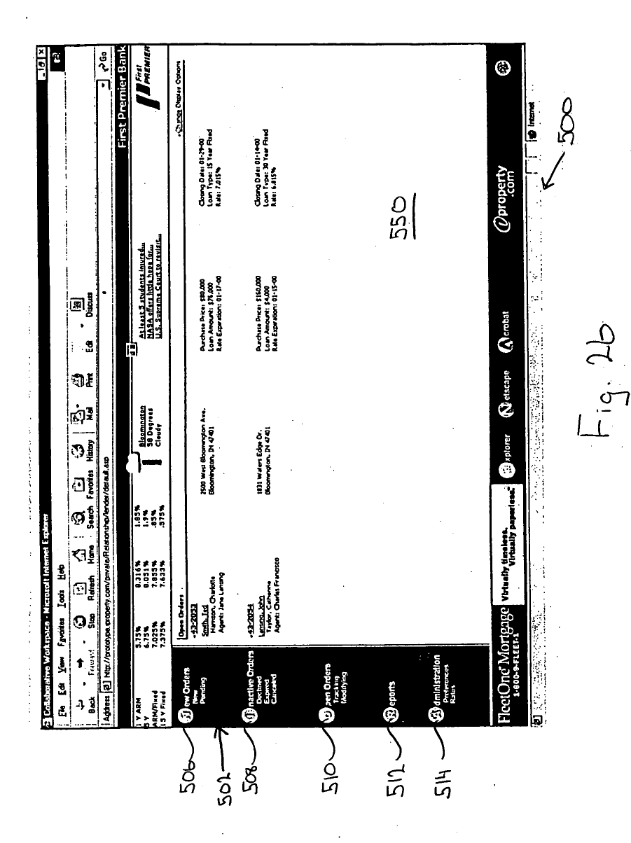

By clicking on the open orders option 510 from the menu 502, the lender is presented with the open order page 550. As shown in FIG. 26, the open order page 550 includes a list of each loan order that has been accepted but the loan has not yet closed. Basic information about each order is listed on the open order page 550, including applicant's name, address, purchase price, loan amount, anticipated closing date, loan type, and loan rate information. By clicking on one of the orders listed, the lender is provided with a detailed information page 551 which provides in-depth information about the status of the loan.

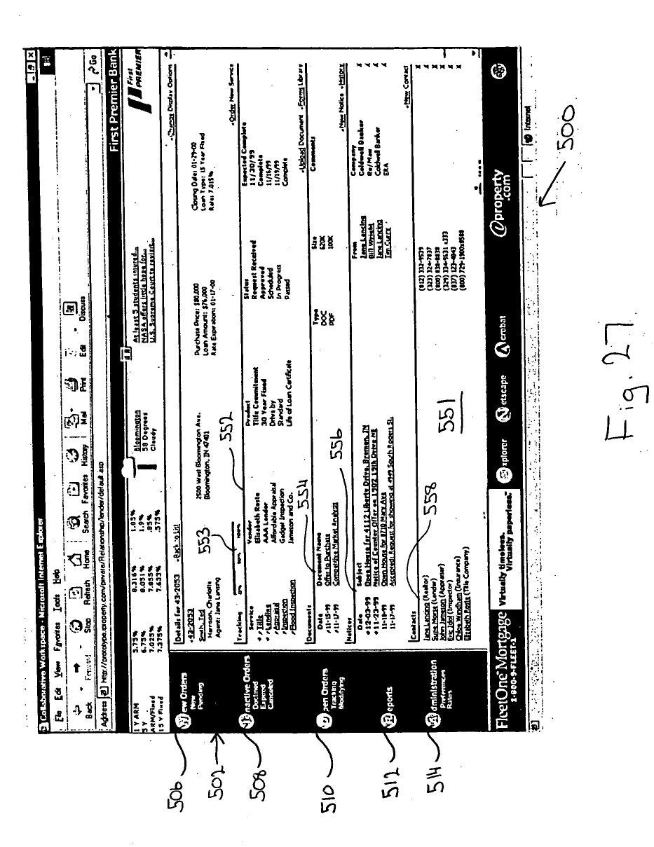

As shown in FIG. 27, the detailed information page 551 includes a tracking block 552 with information about services ordered for closing and a closing meter 553 similar to that provided to the buyer and seller in their respective workspaces. A list of closing documents 554 is also provided to allow the lender to view various documents for submission at closing. The lender is able to view notices related to the particular loan under the notices option 556. Finally, a list of contacts 558 related to the particular loan is provided to the lender. A notice may be sent to one of the contacts by clicking on the contact name. Thus, the lender is able to review all relevant information related to a loan closing though the lender workspace and communicate concerns with respect to the closing to various transaction participants.

4. Reports Option

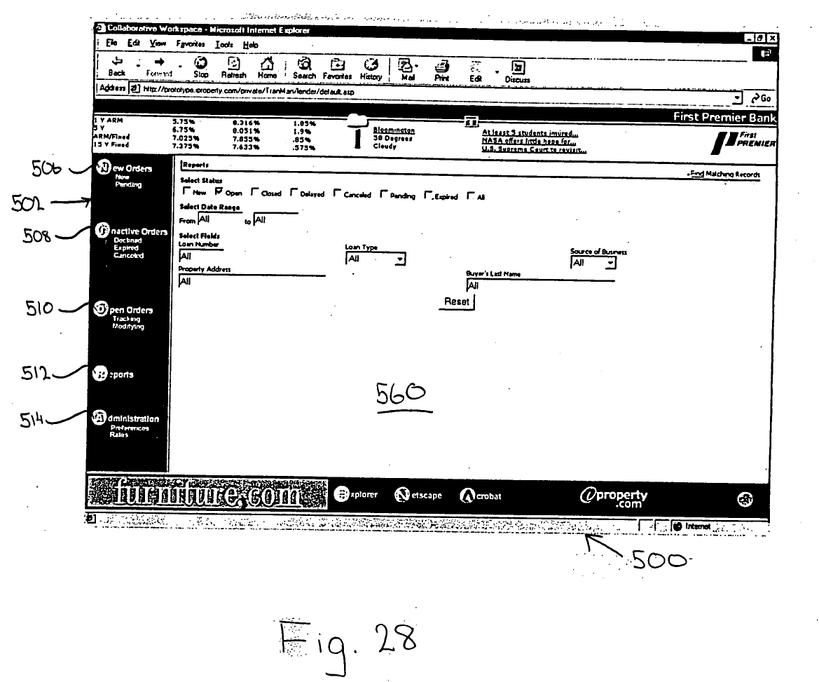

By clicking on the reports option 512 from the menu 502, the lender is provided with the reports page 560 shown in FIG. 28. The reports page 560 allows the lender to search and generate custom reports about loan applications received through the system.

5. Administration Option

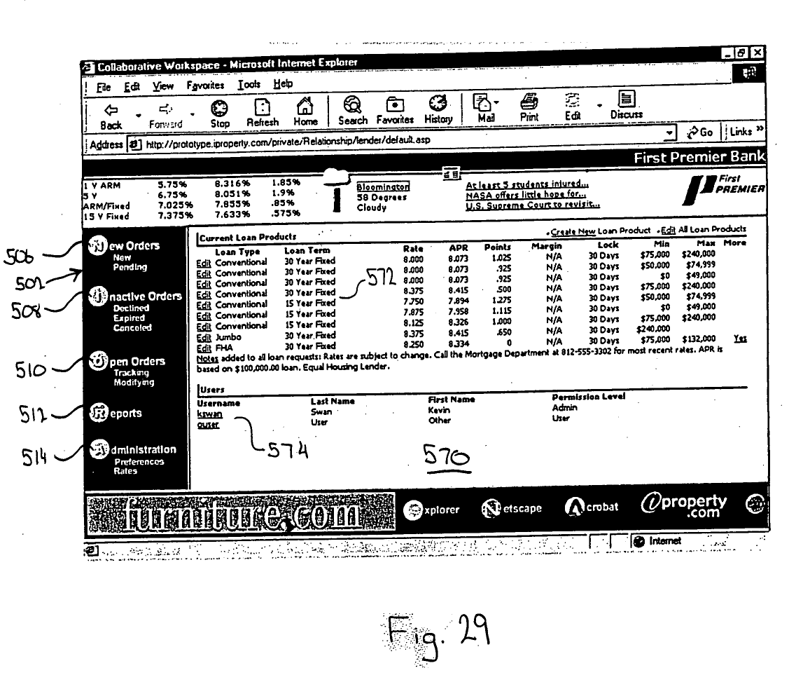

By clicking on the administration option 514 from the menu 502, the lender is provided with the administration page 570. An exemplary administration page 570 is shown in FIG. 29. The administration page 570 provides a list of all loan products 572 currently offered by the lender. These loan products 572 are offered to qualified buyers at the financing page of the buyer workspace following the pre-qualification process. The lender may add or delete loan products available to buyers through the administration page 570. In addition, the lender administration displays a list 574 of all persons authorized to use the lender workspace. Various users may be granted different privileges within the lender workspace. For example, only an administrator may be allowed to edit loan products through the administration page 570, but all users may be granted the privilege to generate reports at the reports page 560.

6. Other Service Provider Workspaces

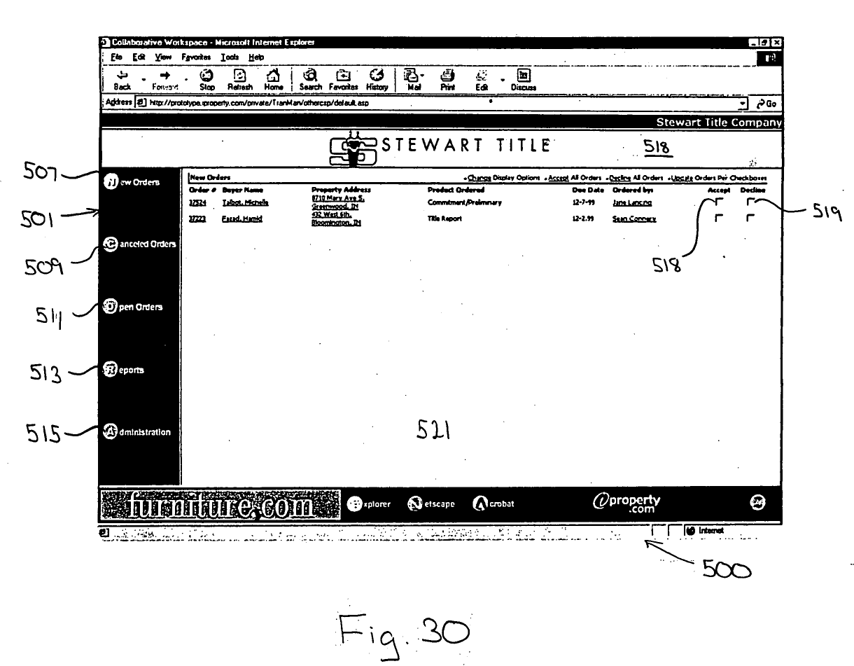

As mentioned previously, other service provider workspaces are similar to the lender workspace. An exemplary service provider workspace 500 of a non-lender is shown in FIG. 30. The workspace shown is for a title company. The service provider workspace 500 includes a banner 518 across the top of the page. The banner 504 includes information requested by the service provider for his particular workspace. This information may include company info, logos, and news links. A menu 501 is provided on the left side of the workspace. The menu includes the following options: new orders 507, canceled orders 509, open orders 511, reports 513 and administration 515.

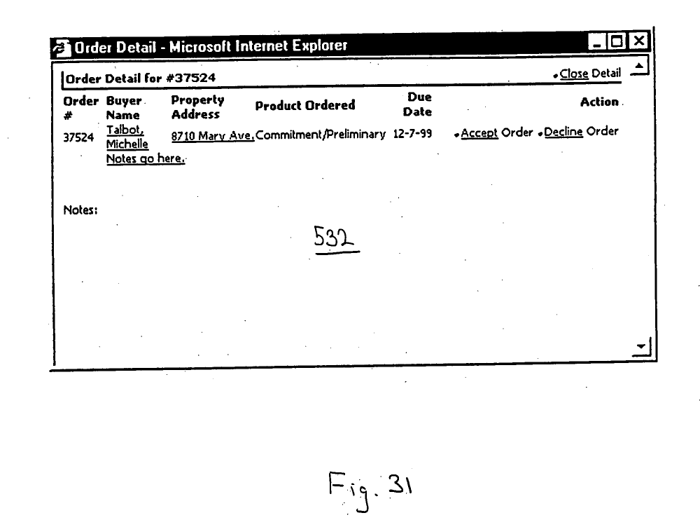

FIG. 30 shows the new orders page 521 for the title company. When a new order is submitted, typically by an agent, information about the new order t is displayed on the new orders page 521. Information about new orders includes the order number, the name of the buyer, the property address, the particular product or service being ordered, the due date of the order, and the individual placing the order. The title company has the option of accepting the new order by choosing the “accept” option 518 or declining the new order by choosing the “decline” option 519. Once an order is accepted or declined, a notice is automatically generated back to the party ordering the service to notify that party of the acceptance or denial of the order. The service provider may view the complete service request 532 for a particular order by clicking on the buyer name from the new orders page 521. An exemplary complete service request 532 is shown in FIG. 31 and includes additional information for the service provider, such as special notes about the service request from the party requesting the service.

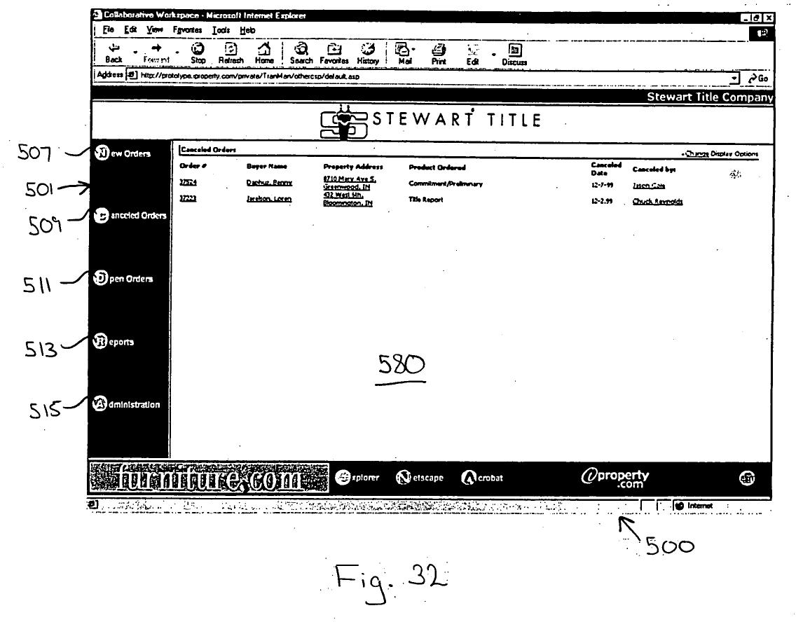

By choosing the canceled orders option 509 from the menu 501 on the service provider workspace 500, the service provider is shown the canceled orders page 580. An exemplary canceled orders page 580 is shown in FIG. 32. Canceled orders are those which have been canceled by the requesting party before the service provider completes the order. The canceled orders page 580 shows a list of each canceled order, including information about order number, buyer name, property address, product or service ordered, and cancellation date. More detailed information about a canceled order is displayed when the service provider clicks on the buyer name or order number.

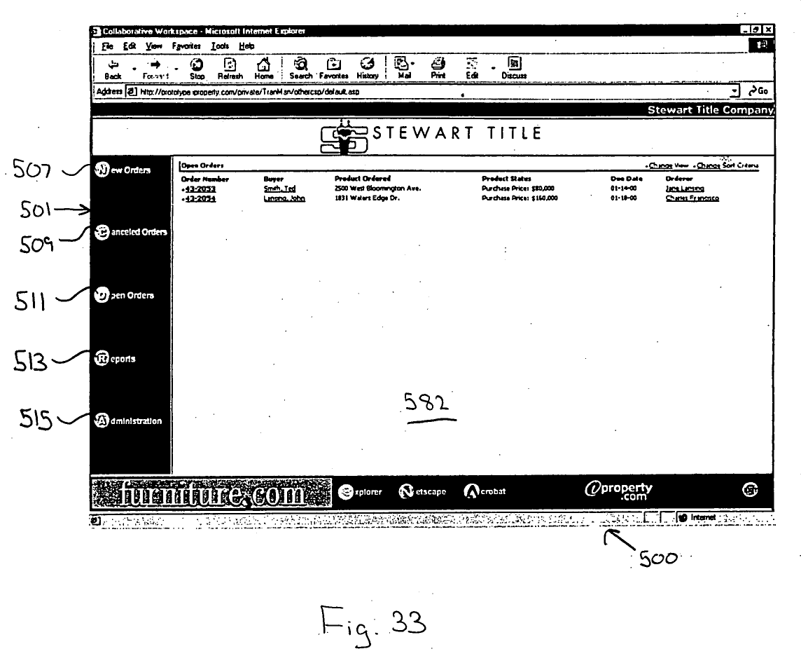

By choosing the open orders option 511 from the menu 501, the service provider is shown the open orders page 582. An exemplary open order page is shown in FIG. 33. Open orders are those orders which have been accepted by the service provider, but are not yet completed. The open orders page 582 shows a list of each open order, including information about order number, buyer name, product or service ordered, status of the order, and order due date. More detailed information about an open order is displayed when the service provider clicks on the buyer name or order number.

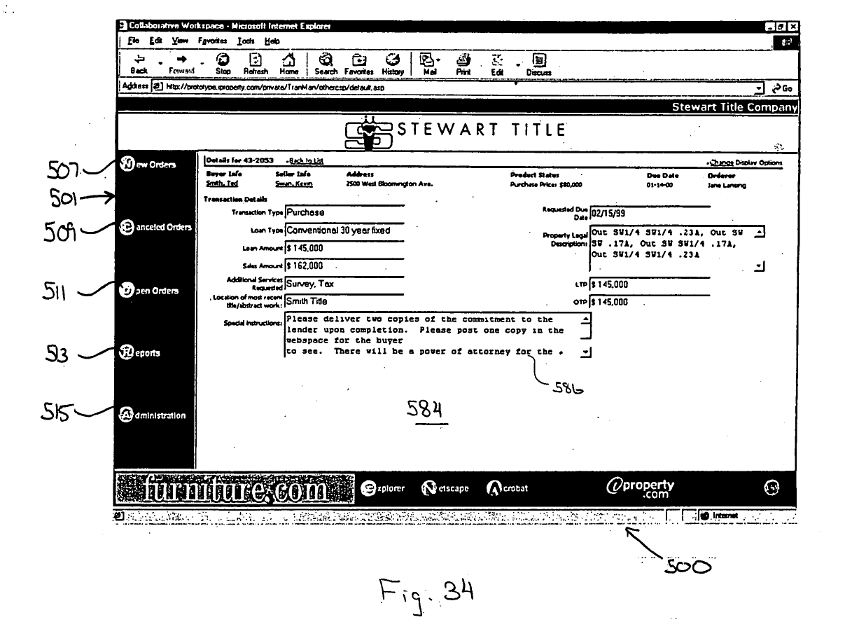

By choosing the reports option 513 from the menu 501, the service provider is shown a list of all orders. After choosing a particular order of interest, the service provider is shown the reports page 584. An exemplary reports page 584 is shown in FIG. 34. The reports page shows a report of detailed information about the transaction, and any special instructions related to the order is displayed to the service provider. This information is used by the service provider to complete the service requested by the party ordering the service as well as any special instructions related to the order. For example, the special instructions box 586 shown on the search page of FIG. 34 instructs the service provider to deliver two copies of the commitment to the lender upon completion as well as delivering one copy to the buyer's workspace.

By choosing the administration option 515 from the menu 501, the service provider is shown an administration page (not shown). The administration page allows the service provider to create new products or services or edit existing products or services offered by the service provider. After making changes to the service provider's products and services, the changes are reflected when other parties attempt to order services. For example, the changes are displayed when the agent attempts to order services from the agent administration screen 282, shown in FIG. 10.

E. Use of the Transaction Management System

In operation, the transaction management system is designed to serve as a central communications platform for all aspects of a real estate transaction. With all parties to the transaction registered to use the system, each party is provided with its own unique workspace allowing that party to communicate with other transaction parties. In addition, each party's workspace assists that party in completing tasks during the real estate transaction. The following description of the use of the transaction management system is provided only as an example of how the system may be used, and is in no way exhaustive of every transaction situation in which the system may be useful.

When a buyer contacts an agent to assist the buyer in finding a home, the agent introduces the system 100 to the buyer. The agent then creates a website for the buyer, entering information about the buyer into the databases, as described above with reference to FIG. 6. After creating the buyer's website 300, the agent provides the buyer with a user name and password that may be used by the buyer to log on to the system and access the buyer's website.

Likewise, an agent creates a seller's website for the seller after the seller requests the agent to list his home in the listings database. When creating the seller's website, information about the seller is entered into the databases, and the seller is associated with the MLS number of the home he is selling. After creating the seller website 400, the agent provides the seller with a user name and password that may be used to log onto the system and access the seller web page. With the buyer and seller both equipped with a website, the transaction parties are in position to find each other and enjoy a streamlined transaction process.

When the buyer first logs on to his new website 300, he is presented with the buyer home page 316, such as illustrated in FIG. 13. Early in the home buying process, the buyer typically uses the buyer website 300 to shop for properties of interest by clicking on the searching option 306. The searching option 306 takes the buyer to the buyer search page 334, shown in FIG. 14. Using the buyer search page 334, the buyer may access information about a number of properties for sale, such as the information shown in FIGS. 9A and 9B. In addition to buyer searches, the agent may recommend properties of interest to the buyer. These recommended properties 338 are shown on the buyer search page 334 to assist the buyer in the searching process.

After shopping for properties using the search page, a buyer may decide that he would like to actually tour a particular house of interest. To inform the agent of his desire, the buyer may use the notice feature by clicking on the agent name from the buyer home page 316. Notices sent from the buyer to the agent will appear as a sent notice 332 on the buyer home page 316. In addition, a dot 229 will appear next to the buyer's name in the notice table 226 of the agent home page 202, as shown in FIG. 3. Once the agent sees that the buyer has sent a notice, the agent will look at the notice and schedule a time for the buyer to see the house of interest. After scheduling the appointment, the agent sends a notice to the buyer to inform him of the appointment. The notice sent from the agent to the buyer is displayed in the notices received 330 block of the buyer home page. Also, the agent home page indicates that the notice was sent from the agent to the buyer in the notice table 226.

When shopping for a home, the buyer may wish to be pre-approved for a certain loan amount. Pre-approval helps the buyer in knowing his limitations. The buyer can apply for pre-approval with a particular lender by entering the financing page 344, as shown in FIG. 15 and requesting pre-approval from a particular lender.

While the buyer workspace assists the buyer in shopping for a home, the seller's workspace 400 helps the seller sell his home. The system 100 not only makes information about the seller's home available to buyers searching the listings database, but also provides valuable information to the seller about market conditions. By viewing the seller statistics 450, shown in FIG. 21, the seller can know how many potential buyers have viewed his home and how many have bookmarked the home. If a large number of potential buyers have bookmarked the home, the buyer knows that there is interest in the home, and may stand confident in his listing price. However, if very few potential buyers have bookmarked the home, the buyer may decide to decrease the listing price of the home to create more interest in the home among potential buyers.

When a buyer decides to make an offer on a particular home, the agent can obtain an offer form through the system, complete the form, and send the offer to the seller. Forms may be obtained from the agent by choosing the tools option from the menu 262. When completing an offer form through the system, information requested on the document which is already entered into the system is automatically entered into the new document. Any new information entered by the buyer is stored for automatic entry into additional documents completed through the system. The offer is then sent to the seller and the seller is notified of the existence of the offer through a notice. The seller, with the help of his agent, may accept the offer or return a counter offer document to the buyer. All forms required during the real estate transaction are available through the system, and may be completed by the buyer, seller, agent, or service provider, depending upon the document and depending upon the system configuration. All documents communicated between buyer and seller are stored on the system databases 108 for future reference.

Once the buyer and seller agree on a purchase price, the buyer may apply for a loan by returning to the buyer financing page 344, shown in FIG. 15, and choosing to apply for a loan 352. Again, when completing the loan application, or any other document provided by the system, information already entered into the system is automatically entered into the loan application document. Thus, because the buyer applied for pre-approval, much of the loan application document will be automatically completed by the system. After the loan application is completed, it is sent to the lender workspace 500, as shown in FIG. 24, for review and approval.

Once the lender approves the loan, the transaction parties begin the process of getting all documents in order for closing. Services, such as appraisal, title services, inspection and insurance may be ordered from third party service providers through the system. The agent typically orders these services by entering the agent administration page 282, shown in FIG. 10, and specifying particular service providers desired for particular jobs. The service requests are then sent to the service providers, and are shown on the new orders page 521 of the service provider workspaces 500. The service providers either accept or deny the requests for services, and their acceptance or denial is communicated to the buyer, seller, and agent by notices delivered to their respective workspaces.

Agent, buyer, and seller may keep track of the documents completed for closing by visiting their respective closing pages, shown respectively in FIGS. 8, 17 and 23. Each closing page is equipped with a closing meter 260 which provides a visual warning to the parties if the transaction is in danger of not closing.

Once all documents are in place for closing, there is no need for the parties to meet at a central location to complete the closing. Instead, by using digital signatures, the parties may sign closing documents through the system. Thus, the present system provides a complete start to finish transaction management system. The system assists buyers, seller, and agents with each step of the transaction process, and streamlines the transaction process, making it more efficient and enjoyable for each party.

F. Instant Auction Feature

Another preferred embodiment of the transaction management system provides an instant auction feature for those participating in the system. According to that embodiment, buyers using the system 100 bookmark properties of interest to the buyers in the manner described above. As shown in FIG. 14, each buyer's bookmarked properties are displayed on the buyer's personalized search page 334. When a buyer delivers an offer on a particular property to a seller using the system, all other buyers that have bookmarked that particular property are informed that another buyer has made an offer on the property. This is accomplished by the system automatically generating a notice that an offer has been made on the particular property, and delivering the notice to each buyer's home page 316, similar to the delivered notices shown in FIG. 13. The notice informing each buyer that an offer has been made may or may not list the amount offered, depending upon the system configuration. When a buyer is notified of a pending offer, the buyer may wish to submit his own offer if he is genuinely interested in the property. If a seller's property is listed below market price, the instant auction feature has the ability to bump the selling price well above the listed price as numerous buyers may be willing to pay a premium for the property in excess of the listed price. If the offer notices sent to buyers include the last offer price, some buyers may be willing to make multiple offers to overcome the most recent high offer. Thus, the instant auction feature provides advantages to both the buyer and the seller. Buyers are assured that they will at least have the opportunity to make an offer on a particular property if it is bookmarked on their search page. At the same time, sellers are assured that the best property offers are available to them before declining offers or making counter-offers to buyers.

The real estate transaction management system described herein thus provides a method and apparatus which completely integrates all parties in a real estate transaction, including agent, buyer, seller, and service providers, and improves communications between the parties. Parties may communicate with each other using a central platform. Communications include informal notices sent between party workspaces as well as formal transaction documents and requests exchanged between party workspaces. When form documents are completed using the transaction management system, data already existing in the system is automatically inserted in to the forms. Thus, the system eliminates the need for redundant data entry. In addition, all documents required for closing are available through the system, and thus the complete real estate transaction may be conducted by using the system. Furthermore, the transaction management system allows agents to provide improved customer service to buyers and sellers and thereby increase the agent's value to the buyers and sellers.

Although the real estate transaction management system has been described in considerable detail with reference to certain preferred versions thereof, other alternative versions are possible. For example, the system described above allows the buyer to request a loan from a lender, but does not allow the buyer to complete forms or order services from other service providers. In an alternative embodiment of the system, buyers and sellers are both provided with the ability to complete forms through their respective websites and order services. Thus, the buyer's website would provide the buyer with the ability to complete an offer to purchase and forward the offer to the seller without the assistance of an agent. Similarly, the seller's website would provide the seller with the ability to complete a counter-offer and forward it to the seller without the assistance of an agent. Also, the buyer could complete a service request, such as a request for inspection, and forward the request to the service provider workspace without the assistance of an agent.

In another alternative version of the invention, the agent workspace is not required. According to this version, buyers and sellers contact a system administrator who sets up websites for the buyers and sellers. The buyers and sellers then use their workspaces to conduct real estate transactions without the need for an agent. To this end, buyers and sellers may make offers and counter-offers, order services from third party service providers, and generally conduct the real estate transaction from their websites.

Of course, in addition to the above versions, many other alternative embodiments are possible. Therefore, the spirit and scope of the appended claims should not be limited to the description of the preferred versions contained herein.

I claim:

1. A real estate transaction management system providing communications between a buyer, a seller, and at least one service provider involved in a real estate transaction, the system linked to a plurality of remote computers over a network and comprising:
a. at least one databases, the at least one databases including a listings database containing information about a plurality of properties;
b. a central computer communicating with the at least one databases to provide a plurality of customized workspaces, the plurality of customized workspaces comprising,
(i) a buyer workspace accessible by the buyer at one of the plurality of remote computers, the buyer workspace including a buyer searching option and a buyer notice option, the buyer searching option providing the buyer with the ability to search for property information in the listings database and the buyer notice option providing the buyer with the ability to view messages from and send messages to other workspaces of the plurality of customized workspaces;
(ii) a seller workspace accessible by the seller at one of the plurality of remote computers, the seller workspace including a seller notice option providing the seller with the ability to view messages from and send messages to other workspaces of the plurality of customized workspaces;
(iii) a service provider workspace accessible by the at least one service provider at one of the plurality of remote computers, the service provider workspace including a service provider notice option providing the at least one service provider with the ability to view messages from and send messages to other workspaces of the plurality of customized workspaces.

2. The real estate transaction management system of claim 1 wherein the buyer workspace further includes a financing option, the financing option providing the buyer with access to a loan application, the ability to complete the loan application, and the ability to submit the loan application to the at least one service provider by sending the loan application to the service provider workspace.

3. The real estate transaction management system of claim 1 wherein the buyer workspace further includes a closing option providing the buyer with a list of closing documents and the ability to view each closing document.

4. The real estate transaction management system of claim 1 wherein the buyer workspace further includes a community option allowing the buyer to indicate an interest in a particular geographic area and providing the buyer with information about recreation, education, government, and business information within the particular geographic area.

5. The real estate transaction management system of claim 1 wherein the searching option of the buyer workspace provides the buyer with the ability to bookmark property information when searching for home information from the listings database, thereby providing the buyer with convenient access to the bookmarked property information during future uses of the real estate transaction management system.

6. The real estate transaction management system of claim 5 wherein information about a property of interest to the seller is contained within the listing database, and the seller workspace further includes a selling option providing the seller with statistical information about the number of times the property of interest to the seller has been bookmarked.

7. The real estate transaction management system of claim 1 wherein information about a property of interest to the seller is contained within the listing database, and the seller workspace further includes a selling option providing the seller with statistical information about the number of times information about the property of interest to the seller has been retrieved from the listing database.

8. The real estate transaction management system of claim 1 wherein the seller workspace further includes an offers option providing the seller with information about offers that have been made to the seller.

9. The real estate transaction management system of claim 1 wherein the seller workspace further includes a closing option providing the buyer with a list of closing documents, the status of each closing document, and the ability to view each closing document.

10. The real estate transaction management system of claim 1 wherein the service provider workspace includes a new orders option which provides the at least one service provider with a list of new service orders for acceptance or rejection by the at least one service provider.

11. The real estate transaction management system of claim 10 wherein a notice is automatically sent to the buyer workspace upon acceptance or rejection of a new service order by the at least one service provider.

12. The real estate transaction management system of claim 1 further providing communications between an agent and the buyer, the seller, and the at least one service provider wherein the plurality of customized workspaces further includes an agent workspace accessible by the agent at one of the plurality of remote computers, the agent workspace including an agent searching option and an agent notice option, the agent searching option providing the agent with the ability to search for property information in the listings database and the agent notice option providing the agent with the ability to view messages from and send messages to other workspaces of the plurality of customized workspaces.

13. The real estate transaction management system of claim 12 further including an agent recommendation option for providing the agent with the ability to recommend one of the plurality of properties to the buyer by posting the recommendation on the buyer workspace.

14. A real estate transaction management system providing communications between an agent, a client, and at least one service provider involved in a real estate transaction, the system linking a plurality of remote computers over a network and comprising:
a. at least one database, the at least one database including a listings database containing information about a plurality of properties;
b. a central computer communicating with the at least one database, the central computer providing an agent workspace accessible by the agent at one of the plurality of remote computers, the agent workspace operable to,
(i) list identification information about the client;
(ii) search the listings database and provide property information contained in the listings database; and
(iii) create a client workspace for use by the client at one of the plurality of remote computers, the client workspace providing the client with the ability to send notices to the agent workspace and search the listings database.

15. The real estate transaction management system of claim 14 wherein the agent workspace is further operable to send a notice to the at least one service provider and order services from the at least one service provider.

16. The real estate transaction management system of claim 14 wherein the agent workspace is further operable to edit the client workspace and provide the client with a plurality of agent recommendations of homes within the listings database.

17. The real estate transaction management system of claim 14 wherein the agent workspace is further operable to provide closing documents for viewing by the agent.

18. A real estate transaction management device connected to a plurality of remote computers to provide communications between a plurality of parties involved in a real estate transaction involving the sale of a property, the plurality of parties including a buyer, a buyer's agent, a seller, a seller's agent, and at least one service provider, the real estate transaction management device comprising:
a. at least one database, the at least one database including a listings database containing information about a plurality of properties and a transaction database including information about the real estate transaction and the plurality of parties;
b. a central computer communicating with the at least one database, the central computer providing
(i) a listing means for allowing the seller's agent to add information about the property to the listings database;
(ii) a searching means for allowing the plurality of buyers and the plurality of agents to search the listings database for the property;
(iii) a form completion means for allowing the plurality of parties to access forms required for closing the real estate transaction, complete the forms, and store the completed forms in the transactions database;
(iv) a communications means for sending messages between the plurality of parties;
(v) a service request means for allowing one of the plurality of parties to order services from the at least one service provider; and
(vi) a document viewing means for listing the completed forms required for closing the real estate transaction and allowing the plurality of parties to view the completed forms.

19. The real estate transaction management device of claim 18 wherein the forms required for completing the real estate transaction include form fields and the form completion means automatically completes the form fields by accessing information about the real estate transaction from the transaction database and entering the information into the form fields.

20. The real estate transaction management device of claim 18 wherein the searching means further comprises a bookmark means for allowing the plurality of buyers to mark properties of interest while using the searching means.

21. The real estate transaction management device of claim 18 wherein the searching means further comprises a recommendation means for allowing the plurality of agents to notify buyers of properties which may be of interest to the buyer.

22. A real estate transaction management system providing communications between a property seller and a plurality of property buyers, the system linking a plurality of remote computers over a network and comprising:
a. at least one database, the at least one database including a listings database containing information about a plurality of houses;
b. a central computer communicating with the at least one database, the central computer providing
(i) a plurality of buyer workspaces respectively accessible by each of the plurality of property buyers at one of the plurality of remote computers, each of the buyer workspaces including a searching tool, a bookmark tool, and a buyer communication tool, whereby the searching tool provides the buyer with the ability to search for information about houses within the listings database, the bookmark tool allows the buyer to save information about houses in the listings database to the buyer workspace as bookmarked properties, and the buyer communication tool provides the buyer with the ability to send an offer to the property seller on one of the bookmarked properties and receive messages from the system indicating that an offer has been made by another buyer on one of the bookmarked properties;
(ii) a seller workspace accessible by the seller at one of the plurality of remote computers, the seller workspace including a seller communication option providing the seller with the ability to receive offers from the plurality of buyers on one of the bookmarked properties.

23. The real estate transaction management system of claim 20 wherein the seller workspace further includes a statistical option which provides the seller with information about the number of buyers who have saved information about one of the plurality of houses as a bookmarked property.

24. The real estate transaction management system of claim 20 wherein the seller workspace further includes a statistical option which provides the seller with information about the number of times that buyers have viewed information from the listings database about one of the plurality of houses.

25. A real estate transaction management system for assisting a plurality of parties to a real estate transaction in closing the real estate transaction, the real estate transaction management system comprising:
a. a transaction database containing information about the real estate transaction and the plurality of parties;
b. a central computer communicating with the transaction database, the central computer providing
(i) a list of documents completed for closing the real estate transaction; and
(ii) a transaction closing meter providing a visual indication of work completed toward closing the real estate transaction.

26. The real estate transaction management system of claim 23 wherein the visual indication of work completed toward closing the real estate transaction provided by the closing meter is based upon completion of particular documents required for closing the transaction.

27. The real estate transaction management system of claim 24 wherein the visual indication of work completed toward closing the real estate transaction provided by the closing meter is expressed as a percentage of total work required to close the real estate transaction.

28. The real estate transaction management system of claim 25 wherein the visual indication of work completed toward closing the real estate transaction provided by the closing meter changes color if particular document completion deadlines are missed.

29. A method of providing communications for a real estate transaction involving a plurality of participants, including a buyer, a seller and a at least one service provider, the method comprising:
a. providing a buyer website accessible by the buyer at one of a plurality of remote computers, the buyer website including a buyer searching page and a buyer notice page;
b. providing a seller website accessible by the seller at one of the plurality of remote computers, the seller website including a seller notice page;
c. providing a service provider website accessible by the at least one service provider at one of the plurality of remote computers, the service provider website including a service provider notice page;
d. providing the buyer with the ability to search for information about a plurality of properties using the buyer searching page;
e. providing the buyer with the ability to view messages from and send messages to the seller notice page and the service provider notice page using the buyer notice page;
f. providing the seller with the ability to view messages from and send messages to the buyer notice page and the service provider notice page using the seller notice page;
g. providing the at least one service provider with the ability to view messages from and send messages to the buyer notice page and the seller notice page using the service provider notice page.

30. The method of claim 27 wherein the plurality of participants further includes an agent, and the method further comprises providing an agent website accessible by the agent at one of the plurality of remote computers, the agent website including an agent searching page and an agent notice page, the agent searching page providing the agent with the ability to search for information about the plurality of properties and the agent notice page providing the agent with the ability to view messages from and send messages to the buyer notice page, the seller notice page and the service provider notice page.

31. The method of claim 27 further comprising providing the buyer with a financing page on the buyer website, the financing page providing the buyer with access to a loan application, the ability to complete the loan application, and the ability to submit the loan application to the service provider website.

32. The method of claim 27 further comprising providing a buyer closing page on the buyer website, the buyer closing page providing the buyer with a list of closing documents, the status of each closing document, and the ability to view each closing document.

33. The method of claim 27 further comprising providing a seller closing page on the seller website, the seller closing page providing the buyer with a list of closing documents, the status of each closing document, and the ability to view each closing document.

34. The method of claim 28 further comprising providing an agent closing page on the agent website, the agent closing page providing the agent with a list of closing documents, the status of each closing document, and the ability to view each closing document.

35. The method of claim 28 further comprising providing an administration page on the agent website, the administration page providing the agent with the ability to order a service from the at least one service provider such that the ordered service appears on the service provider website as a new service order.

36. The method of claim 33 further comprising providing new order page on the service provider website, the new order page providing the at least one service provider with a list of new service orders.

37. The method of claim 28 further comprising providing a form completion page, the form completion page providing the buyer with the ability to submit an offer on a property to the seller.

38. The method of claim 28 wherein the agent website provides the agent with the ability to recommend properties to the buyer, and the information about the property is included on the buyer website.

39. The method of claim 27 wherein thee buyer searching page further allows the buyer to save information about one of the plurality of properties to the buyer website.

40. The method of claim 37 further comprising providing statistical information to the seller website when the buyer saves information about the one of the plurality of properties to the buyer website.

41. The method of claim 37 further comprising posting a notice on the buyer notice page when the seller receives an offer on the one of the plurality of properties.

42. The method of claim 32 further comprising providing a closing meter on the agent closing page, the closing meter providing the agent with a visual indication of the progress of the real estate transaction towards closing.
